(19) United States
(12) Patent Application Publication
(10) Pub. No.: US 2015/0322200 A1
(43) Pub. Date: Nov. 12, 2015

(54) AMORPHOUS POLYESTER COMPOSITIONS

(71) Applicant: SABIC Global Technologies B.V., Bergen op Zoom (NL)

(72) Inventors: Navinchandra Asthana, Evansville, IN (US); Ganesh Kannan, Evansville, IN (US); Robert R. Gallucci, Mt. Vernon, IN (US)

(73) Assignee: SABIC Global Technologies B.V., Bergen op Zoom (NL)

(21) Appl. No.: 14/272,160

(22) Filed: May 7, 2014

(51) Int. Cl. C08G 63/672; C08L 67/03

(52) U.S. Cl. CPC C08G 63/672; C08L 67/03; C08L 2201/10

(57) ABSTRACT

Disclosed herein are polyester compositions comprising the reaction product of: a) a precursor component comprising xanthene dicarboxylic acid (XDA), or a reactive derivative thereof; b) a terephthalate component comprising at least one di(C1-C3 alkyl) terephthalate, or terephthalic acid, or a combination thereof; c) a diol component comprising 1,4-cyclohexane dimethanol (CHDM); and d) at least one metal catalyst; methods of making same, and articles comprising the disclosed compositions. This abstract is intended as a scanning tool for purposes of searching in the particular art and is not intended to be limiting of the present disclosure.

### BACKGROUND

Thermoplastic polyesters are readily molded into useful articles, and articles comprising polyesters have valuable characteristics including strength, toughness, high gloss, and solvent resistance. Polyesters therefore have utility in a wide range of applications, including automotive parts, electric appliances, and electronic devices. Although polyesters can have a range of desirable performance properties, most commercially available amorphous polyesters, such as polyethylene terephthalate (PET), glycol-modified polyethylene terephthalate (PETG), and glycol-modified polycyclohexylenedimethylene terephthalate (PCTG), exhibit good impact properties, but have significantly limited applications due to their low glass transition temperatures.

Accordingly, there remains a need for new amorphous polyesters with improved heat performance. In many applications, transparent non-crystalline polyesters with good ductility and higher heat capability are also needed. Such shortcomings are addressed by the various aspects of the present disclosure.

### SUMMARY

The present disclosure relates to a polyester composition comprising the reaction product of: a) a precursor component comprising xanthene dicarboxylic acid (XDA), or xanthene ester, or a combination thereof; b) a terephthalate component comprising at least one di(C1-C3 alkyl) terephthalate, or terephthalic acid, or a combination thereof; c) a diol component comprising 1,4-cyclohexane dimethanol (CHDM); and d) at least one metal catalyst present in and amount of from about 50 ppm to about 300 ppm; wherein the polyester composition exhibits a glass transition temperature (Tg) of at least about 105° C.; wherein the polyester composition exhibits an intrinsic viscosity of at least about 0.7 dl/g; and wherein the polyester composition has a lead content of less than about 10 ppm.

In one aspect, the disclosure relates to a polyester composition comprising the reaction product of: a) a precursor component comprising xanthene dicarboxylic acid (XDA); b) a terephthalate component comprising diethyl terephthalate or dimethyl terephthalate; c) 1,4-cyclohexane dimethanol (CHDM); and d) at least one metal catalyst present in and amount of from about 50 ppm to about 300 ppm; wherein the polyester composition exhibits a Tg of at least about 105° C.; wherein the polyester composition exhibits an intrinsic viscosity of at least about 0.7 dl/g; and wherein the polyester composition has a lead content of less than about 10 ppm.

In various further aspects, the disclosure relates to compositions and articles comprising the disclosed polyester compositions.

In a further aspect, the disclosure relates to methods of making the disclosed compounds and compositions.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

The present disclosure can be understood more readily by reference to the following detailed description of the disclosure and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### DEFINITIONS

It is also to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polyester polymer” includes mixtures of two or more polyester polymers.

As used herein, the term “combination” is inclusive of blends, mixtures, alloys, reaction products, and the like.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted alkyl” means that the alkyl group can or cannot be substituted and that the description includes both substituted and unsubstituted alkyl groups.

As used herein, the term “effective amount” refers to an amount that is sufficient to achieve the desired modification of a physical property of the composition or material. For example, an “effective amount” of an additive refers to an amount that is sufficient to achieve the desired improvement in the property modulated by the formulation component, e.g. achieving the desired level of stiffness, while not negatively impacting other desired properties of the thermoplastic composition. The specific level in terms of wt % in a composition required as an effective amount will depend upon a variety of factors including the amount and type of polymer, amount and type of additives, and end use of the article made using the composition.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

Compounds are described using standard nomenclature. For example, any position not substituted by any indicated group is understood to have its valence filled by a bond as indicated, or a hydrogen atom. A dash (“—”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this disclosure belongs.

The term “alkyl group” as used herein is a branched or unbranched saturated hydrocarbon group of 1 to 24 carbon atoms, such as methyl, ethyl, n propyl, isopropyl, n butyl, isobutyl, t butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “aryl group” as used herein is any carbon-based aromatic group including, but not limited to, benzene, naphthalene, etc. The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “aralkyl” as used herein is an aryl group having an alkyl, alkynyl, or alkenyl group as defined above attached to the aromatic group. An example of an aralkyl group is a benzyl group.

The term “carbonate group” as used herein is represented by the formula OC(O)OR, where R can be hydrogen, an alkyl, alkenyl, alkynyl, aryl, aralkyl, cycloalkyl, halogenated alkyl, or heterocycloalkyl group described above.

The term “organic residue” defines a carbon containing residue, i.e., a residue comprising at least one carbon atom, and includes but is not limited to the carbon-containing groups, residues, or radicals defined hereinabove. Organic residues can contain various heteroatoms, or be bonded to another molecule through a heteroatom, including oxygen, nitrogen, sulfur, phosphorus, or the like. Examples of organic residues include but are not limited alkyl or substituted alkyls, alkoxy or substituted alkoxy, mono or di-substituted amino, amide groups, etc. Organic residues can preferably comprise 1 to 18 carbon atoms, 1 to 15, carbon atoms, 1 to 12 carbon atoms, 1 to 8 carbon atoms, 1 to 6 carbon atoms, or 1 to 4 carbon atoms. In a further aspect, an organic residue can comprise 2 to 18 carbon atoms, 2 to 15, carbon atoms, 2 to 12 carbon atoms, 2 to 8 carbon atoms, 2 to 4 carbon atoms, or 2 to 4 carbon atoms.

A very close synonym of the term “residue” is the term “radical,” which as used in the specification and concluding claims, refers to a fragment, group, or substructure of a molecule described herein, regardless of how the molecule is prepared. For example, a 2,4-dihydroxyphenyl radical in a particular compound has the structure:

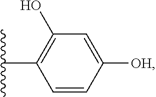 [SMILES: *c1ccc(O)cc1O]

regardless of whether 2,4-dihydroxyphenyl is used to prepare the compound. In some embodiments the radical (for example an alkyl) can be further modified (i.e., substituted alkyl) by having bonded thereto one or more “substituent radicals.” The number of atoms in a given radical is not critical to the present disclosure unless it is indicated to the contrary elsewhere herein.

“Organic radicals,” as the term is defined and used herein, contain one or more carbon atoms. An organic radical can have, for example, 1-26 carbon atoms, 1-18 carbon atoms, 1-12 carbon atoms, 1-8 carbon atoms, 1-6 carbon atoms, or 1-4 carbon atoms. In a further aspect, an organic radical can have 2-26 carbon atoms, 2-18 carbon atoms, 2-12 carbon atoms, 2-8 carbon atoms, 2-6 carbon atoms, or 2-4 carbon atoms. Organic radicals often have hydrogen bound to at least some of the carbon atoms of the organic radical. One example, of an organic radical that comprises no inorganic atoms is a 5,6,7,8-tetrahydro-2-naphthyl radical. In some embodiments, an organic radical can contain 1-10 inorganic heteroatoms bound thereto or therein, including halogens, oxygen, sulfur, nitrogen, phosphorus, and the like. Examples of organic radicals include but are not limited to an alkyl, substituted alkyl, cycloalkyl, substituted cycloalkyl, mono-substituted amino, di-substituted amino, acyloxy, cyano, carboxy, carboalkoxy, alkylcarboxamide, substituted alkylcarboxamide, dialkylcarboxamide, substituted dialkylcarboxamide, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic radicals, wherein the terms are defined elsewhere herein. A few non-limiting examples of organic radicals that include heteroatoms include alkoxy radicals, trifluoromethoxy radicals, acetoxy radicals, dimethylamino radicals and the like.

As used herein, the intrinsic viscosity (IV) was measured using ASTM D2857.

As used herein, “polyester” and “polyester composition” refer to an oligomer or polymer comprising residues of one or more dicarboxylic acid compounds, e.g., dialkyl ester compounds or the parent dicarboxylic acid; the terms also encompasses homopolyesters and copolyesters both linear and branched.

The terms “residues” and “structural units”, used in reference to the constituents of the polymers, are synonymous throughout the specification.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

As briefly described above, the present disclosure relates to polyester compositions.

In various aspects, the polyester composition comprises a polyester. In further aspects, the polyester composition comprises an amorphous copolyester.

In general, polyesters, as described herein, are produced by polymerization of at least one dicarboxylic acid or reactive derivative thereof and a diol or reactive derivative thereof, and have repeating units of formula (A):

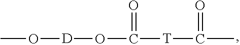

wherein T is a residue derived from a dicarboxylic acid or chemical equivalents thereof, and D is a residue derived from a diol or chemical equivalents thereof. Chemical equivalents of diacids include dialkyl esters, e.g., dimethyl esters, diaryl esters, anhydrides, salts, acid chlorides, acid bromides, and the like. Chemical equivalents of diols include esters, such as dialkylesters, diaryl esters, and the like.

In addition to units comprising a dicarboxylic acid or chemical equivalent thereof, and a diol or chemical equivalent thereof, other T and/or D units can be present in the polyester, provided that the type or amount of such units does not significantly adversely affect the desired properties of the thermoplastic compositions.

In various aspects, the polyester compositions of the present disclosure are produced by polymerization of a dicarboxylic acid, ester, or reactive derivative thereof, and a diol or reactive derivative thereof. In a further aspect, the polyester compositions are produced by polymerization of a precursor component: (a) xanthene dicarboxylic acid (XDA) or a reactive derivative thereof; or xanthene ester or a reactive derivative thereof; and (b) a terephthalic acid or reactive derivative thereof, comprising a dialkyl terephthalate. In some aspects, the precursor component of (a) is xanthene dicarboxylic acid (XDA) or a reactive derivative thereof. In other aspects, the precursor component of (a) is xanthene ester or a reactive derivative thereof. In further aspects, the diol is 1,4-cyclohexanedimethanol or a reactive derivative thereof.

In one aspect, the precursor component comprises at least one dicarboxylic acid monomer. In another aspect, the precursor component comprises a monomer comprising a carboxylic acid and an ester. In a further aspect, the precursor component comprises at least one ester monomer. In a further aspect, the precursor component comprises xanthene dicarboxylic acid (XDA), or xanthene ester, a combination thereof.

In some aspects, the precursor component is xanthene dicarboxylic acid (XDA). In further aspects, non-limiting examples of xanthene dicarboxylic acids include 9,9-dimethylxanthene 2,6-dicarboxylic acid, 9,9-dimethylxanthene 2,7-dicarboxylic acid, or 9,9-dimethylxanthene 3,6-dicarboxylic acid, or a combination thereof. In one aspect, xanthene dicarboxylic acid comprises 9,9-dimethylxanthene 3,6-dicarboxylic acid or 9,9-dimethylxanthene 2,7-dicarboxylic acid or a combination thereof.

One method for the preparation of xanthene dicarboxylic acids is described in U.S. Pat. No. 5,430,199, which is incorporated herein in its entirety.

In some instances, the xanthene dicarboxylic acid can be an alkyl substituted, for example as in the formula below wherein Ra and Rb can hydrogen or C₁ to C₁₂ alkyl, aryl or alkylaryl group; for example, methyl, ethyl, propyl, cyclohexyl, isodecyl, phenyl, phenyl methyl and the like. Ra and Rb can be the same or different. In one aspect, Ra and Rb are both methyl.

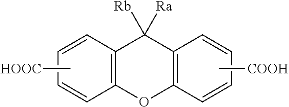

In other instances the 9,9 substituted xanthene dicarboxylic acid can be the 3,6-dicarboxylic acid shown below.

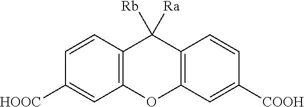

In yet other instances the 9,9 substituted xanthene dicarboxylic acid can be the 2,7-dicarboxylic acid shown below.

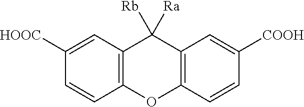

In one aspect, the xanthene dicarboxylic acid can be 9,9-dimethyl xanthene-3,6-dicarboxylic acid or 9,9-dimethyl xanthene-2,7-dicarboxylic acid both shown below, or any mixture thereof.

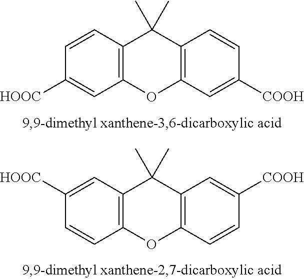 [SMILES: CC1(C)c2ccc(C(=O)O)cc2Oc2cc(C(=O)O)ccc21 ; CC1(C)c2cc(C(=O)O)ccc2Oc2ccc(C(=O)O)cc21]

Non limiting examples of xanthene dicarboxylic acids are: 9,9-dimethyl xanthene-3,6-dicarboxylic acid, 9,9-dimethyl xanthene-2,7-dicarboxylic acid, 9,9-diethyl xanthene-3,6-dicarboxylic acid, 9,9-diphenyl xanthene-2,7-dicarboxylic acid, 9,9-dipropyl xanthene-3,6-dicarboxylic acid, 9-methyl-9-ethyl xanthene-2,7-dicarboxylic acid, 9-methyl-9-phenyl xanthene-3,6-dicarboxylic acid, 9-phenyl xanthene-2,7-dicarboxylic acid and the like and any mixture thereof.

In one aspect, the precursor component comprises an ester monomer. In another aspect, the C1 to C3 alkyl esters of the various xanthene dicarboxylic acids or any mixture of acids and esters can also be used in the polymer synthesis. Any mixture of isomers can be used in the polyester synthesis. In a further aspect, the C1 to C3 alkyl esters of the various xanthene dicarboxylic acids, or any mixture of acids and esters can also be used in the polymer synthesis. Any mixture of isomers can be used in the polyester synthesis. In a further aspect, the C1 to C3 alkyl ester comprises methyl ester, ethyl ester, or propyl ester, ethyl methyl esters, ester acids (half esters) or a combination thereof. Non limiting examples of xanthene dicarboxylate esters are: dimethyl 9,9-dimethyl xanthene-3,6-dicarboxylate, dimethyl 9,9-dimethyl xanthene-2,7-dicarboxylate, diethyl 9,9-dimethyl xanthene-3,6-dicarboxylate, diethyl 9,9-dimethyl xanthene-2,7-dicarboxylate, dipropyl 9,9-dimethyl xanthene-3,6-dicarboxylate, dimethyl 9,9-diethyl xanthene-2,7-dicarboxylate, dimethyl 9-methyl 9-phenyl xanthene-3,6-dicarboxylate, dimethyl 9,9-diphenyl xanthene-2,7-dicarboxylate and the like and any mixture thereof. In a further aspect, the precursor component comprises xanthene methyl esters, xanthene dimethyl esters, xanthene methyl ester carboxylic acids, xanthene ethyl esters, xanthene diethyl esters, xanthene ethyl ester carboxylic acids, xanthene propyl ester, xanthene dipropyl esters, or xanthene propyl ester carboxylic acids, or a combination thereof.

In a further aspect, the polyester composition comprises from about 5 to about 95 mol % xanthene dicarboxylic acid units (a) based on the total moles of repeating units in the polyester composition. In a still further aspect, the polyester composition comprises from about 15 to about 95 mol % dicarboxylic acid units (a) based on the total moles of repeating units in the polyester composition. In a yet further aspect, the polyester composition comprises from about 25 to about 95 mol % dicarboxylic acid units (a) based on the total moles of repeating units in the polyester composition.

In a further aspect, the polyester composition comprises from about 5 to about 30 mol % xanthene dicarboxylic acid units (a) based on the total moles of repeating units in the polyester composition. In a still further aspect, the polyester composition comprises from about 15 to about 50 mol % dicarboxylic acid units (a) based on the total moles of repeating units in the polyester composition. In a yet further aspect, the polyester composition comprises from about 50 to about 95 mol % dicarboxylic acid units (a) based on the total moles of repeating units in the polyester composition.

In a further aspect, the polyester composition comprises from about 5 to about 50 mol % xanthene dicarboxylic acid units (a), and from about 50 to about 95 mol % terephthalate units (b); wherein the total moles of each component is based on the total moles of repeating dicarboxylic acid units (a) and terephthalate units (b) in the polyester composition. In a still further aspect, the polyester composition comprises from about 5 to about 30 mol % xanthene dicarboxylic acid units (a), and from about 70 to about 95 mol % terephthalate units (b); wherein the total moles of each component is based on the total moles of repeating dicarboxylic acid units (a) and terephthalate units (b) in the polyester composition.

In a further aspect, the polyester composition comprises from about 5 to about 95 mol % precursor component units (a) based on the total moles of repeating units in the polyester composition. In a still further aspect, the polyester composition comprises from about 15 to about 95 mol % precursor component units (a) based on the total moles of repeating units in the polyester composition. In a yet further aspect, the polyester composition comprises from about 25 to about 95 mol % precursor component units (a) based on the total moles of repeating units in the polyester composition.

In a further aspect, the polyester composition comprises from about 5 to about 30 mol % precursor component units (a) based on the total moles of repeating units in the polyester composition. In a still further aspect, the polyester composition comprises from about 15 to about 50 mol % precursor component units (a) based on the total moles of repeating units in the polyester composition. In a yet further aspect, the polyester composition comprises from about 50 to about 95 mol % precursor component units (a) based on the total moles of repeating units in the polyester composition.

In a further aspect, the polyester composition comprises from about 5 to about 50 mol % precursor component units (a), and from about 15 to about 95 mol % terephthalate units (b); wherein the total moles of each component is based on the total moles of repeating precursor component units (a) and terephthalate units (b) in the polyester composition. In a still further aspect, the polyester composition comprises from about 5 to about 30 mol % precursor component units (a), and from about 15 to about 90 mol % terephthalate units (b); wherein the total moles of each component is based on the total moles of repeating precursor component units (a) and terephthalate units (b) in the polyester composition.

In a further aspect, the polyester composition comprises from about 5 to about 50 mol % xanthene dicarboxylic acid (XDA), or xanthene ester, or a combination thereof; wherein the total moles is based on the total moles of repeating dicarboxylic acid units (a) and terephthalate units (b) in the polyester composition. In a still further aspect, the polyester composition comprises from about 5 to about 30 mol % xanthene dicarboxylic acid (XDA), or xanthene ester, or a combination thereof; wherein the total moles is based on the total moles of repeating dicarboxylic acid units (a) and terephthalate units (b) in the polyester composition.

The C₁ to C₃ alkyl esters of the various xanthene dicarboxylic acids, or any mixture of acids and esters can also be used in the polymer synthesis. Any mixture of isomers can be used in the polyester synthesis. In some instances any mixture of xanthene dicarboxylic acids and tetramethyl dicarboxylic acids can further be used in the polyester synthesis.

In one aspect, the terephthalate component comprises at least one di(C₁₋₃ alkyl) terephthalate, or terephthalic acid, or a combination thereof. In a further aspect, the terephthalate component comprises a (C₁₋₃)alkyl ester of terephthalic acid. In a yet further aspect, the terephthalate component comprises a dimethyl terephthalate (DMT) or a diethyl terephthalate (DET). In still a further aspect, the terephthalate component is diethyl terephthalate (DET). In an even further aspect, the terephthalate component is dimethyl terephthalate (DMT).

In the synthesis of polyesters such as XDA polyesters with higher boiling diols such as CHDM, and other diols with 8 or more carbon atoms, it is much more important to control diol/diester-diacid stoichiometry than it is with lower diols (4 carbon atoms or less). In the synthesis of polyesters using such lower diols (such as PBT and PET) an excess of diol can be employed, the excess then removed as polymer IV builds keeping the diester/diacid content intact. In polyesters made with the higher boiling diols such as CHDM such removal of excess higher boiling diol may also cause loss of diester such as dimethyl terephthalate (DMT). In our process we use diethyl terephthalate (DET) which boils at 302° C. (atmospheric pressure) rather than DMT which has a lower boiling point (288° C.). While use of DMT can allow the build of higher IV resin but the use of DET makes the polymerization process easier and more efficient especially when vacuum is employed. The use of DET facilitates building of high IV by this process.

In a further aspect, the polyester composition comprises from about 15 to about 95 mol % terephthalate units (b) comprising at least one di(C₁₋₃ alkyl) terephthalate, or terephthalic acid, or a combination thereof; wherein the total moles of the component is based on the total moles of repeating precursor component units (a) and terephthalate units (b) in the polyester composition. In a still further aspect, the polyester composition comprises from about 15 to about 90 mol % terephthalate units (b) comprising at least one di(C₁₋₃ alkyl) terephthalate, or terephthalic acid, or a combination thereof; wherein the total moles of each component is based on the total moles of repeating precursor component units (a) and terephthalate units (b) in the polyester composition.

In a further aspect, the polyester composition comprises from about 15 to about 95 mol % dimethyl terephthalate (DMT) or diethyl terephthalate (DET), or a combination thereof; wherein the total moles of the component is based on the total moles of repeating precursor component units (a) and terephthalate units (b) in the polyester composition. In a still further aspect, the polyester composition comprises from about 15 to about 90 mol % dimethyl terephthalate (DMT) or diethyl terephthalate (DET), or a combination thereof; wherein the total moles of each component is based on the total moles of repeating precursor component units (a) and terephthalate units (b) in the polyester composition.

In a further aspect, the polyester composition comprises from about 15 to about 85 mol % dimethyl terephthalate (DMT) or diethyl terephthalate (DET), or a combination thereof; wherein the total moles of the component is based on the total moles of repeating precursor component units (a) and terephthalate units (b) in the polyester composition. In a still further aspect, the polyester composition comprises from about 15 to about 75 mol % dimethyl terephthalate (DMT) or diethyl terephthalate (DET), or a combination thereof; wherein the total moles of each component is based on the total moles of repeating precursor component units (a) and terephthalate units (b) in the polyester composition.

In a further aspect, the polyester composition comprises from about 15 to about 50 mol % terephthalate units (b) based on the total moles of repeating units in the polyester composition. In a still further aspect, the polyester composition comprises from about 15 to about 45 mol % terephthalate units (b) based on the total moles of repeating units in the polyester composition. In a yet further aspect, the polyester composition comprises from about 25 to about 50 mol % terephthalate units (b) based on the total moles of repeating units in the polyester composition.

In one aspect, the polyester comprises a residue comprising 1,4-cyclohexane dimethanol (CHDM). In a further aspect, the 1,4-cyclohexane dimethanol has an isomer distribution of from about 50 to about 80% trans isomers and from about 20 to about 50% cis isomers. In a still further aspect, In a still further aspect, the 1,4-cyclohexane dimethanol (CHDM) has an isomer distribution of about 70% trans isomers and about 30% cis isomers.

In a further aspect, the polyester composition comprises from about 10 to about 50 mol % diol units (c) comprising 1,4-cyclohexane dimethanol (CHDM) units based on the total moles of repeating units in the polyester composition. In a still further aspect, the polyester composition comprises from about 20 to about 50 mol % diol units (c) comprising 1,4-cyclohexane dimethanol (CHDM) units based on the total moles of repeating units in the polyester composition. In a yet further aspect, the polyester composition comprises from about 25 to about 50 mol % diol units (c) comprising 1,4-cyclohexane dimethanol (CHDM) units based on the total moles of repeating units in the polyester composition.

In a further aspect, the polyester composition comprises from about 70 to about 99 mol % 1,4-cyclohexane dimethanol (CHDM); wherein the total moles is based on the total moles of repeating diol units (c) in the polyester composition. In a still further aspect, the polyester composition comprises from about 75 to about 95 mol % 1,4-cyclohexane dimethanol (CHDM); wherein the total moles is based on the total moles of repeating diol units (c) in the polyester composition. In a yet further aspect, the polyester composition comprises from about 80 to about 90 mol % 1,4-cyclohexane dimethanol (CHDM); wherein the total moles is based on the total moles of repeating diol units (c) in the polyester composition. Mixtures of 1,3- and 1,4-CHDM may be used. In these instances higher levels of xanthene diacid may be needed to achieve a Tg of 105° C. or more.

Polyesters can be obtained by interfacial polymerization or melt-process condensation, by solution phase condensation, or by transesterification or direct esterification polymerization using acid or metal catalysis. Melt polymerization is preferred. The catalyst facilitates the transesterification or direct esterification reactions, and can comprise cerium compounds, zinc compounds, antimony compounds, tin compounds, titanium compounds, germanium compounds, zirconium compounds, and combinations thereof, as well as many other metal and organometallic catalysts and combinations of metal catalysts that have been disclosed in the literature. The amount of catalyst required to obtain an acceptable polymerization rate at the desired polymerization temperature will vary, and can be determined by experimentation. In some aspects, the catalyst amount can be 1 to 5000 ppm, or more. In further aspects, the catalyst amount can be 50 to 300 ppm. In one aspect, when an alkyl ester of the dicarboxylic acid compound is employed, an ester interchange type of catalyst is preferred, such as Ti(OC₄H₉)₆ in n-butanol. In some instances it is highly desired that the metal or organo metallic catalysts employed be free (in some instances less than 10 ppm) of heavy metals such as; lead, mercury, cadmium, arsenic, thallium or mixtures thereof.

For example, in one aspect, the present disclosure provides a method for preparing a polyester composition, the method comprising: a) providing a precursor component comprising at least one dicarboxylic acid monomer; b) providing a terephthalate component comprising at least one di(C1-3 alkyl) terephthalate, or terephthalic acid, or a combination thereof; c) providing 1,4-cyclohexane dimethanol (CHDM); and d) reacting the precursor component, terephthalate component, and 1,4-cyclohexane dimethanol (CHDM) under conditions effective to provide a reaction product comprising a polyester; wherein the polyester exhibits a Tg of at least about 105° C., and wherein the polyester exhibits an intrinsic viscosity of at least about 0.7 dl/g. In a further aspect, the precursor component, terephthalate component, and 1,4-cyclohexane dimethanol (CHDM) are reacted in the presence of a catalyst.

In one aspect, it is possible to prepare a branched polyester in which a branching agent, for example, a glycol having three or more hydroxyl groups or a trifunctional or multifunctional carboxylic acid has been incorporated. In a further aspect, it is sometimes desirable to have various concentrations of acid and hydroxyl end groups on the polyester, depending on the ultimate end use of the composition.

In various aspects, the polyester compositions of the present disclosure have an intrinsic viscosity of at least 0.7 deciliters per gram (dL/g), as measured in phenol/tetrachloroethane (60:40, volume/volume ratio) at 25° C. In a further aspect, the polyester composition has an intrinsic viscosity (as measured in phenol/tetrachloroethane (60:40, volume/volume ratio) at 25° C.) ranging from at least about 0.7 to about 2.0 deciliters per gram. In a yet further aspect, the polyester composition has an intrinsic viscosity (as measured in chloroform at 25° C.) ranging from at least about 0.7 to about 1.2 deciliters per gram (dL/g). In a still further aspect, the polyester composition has an intrinsic viscosity (as measured in chloroform at 25° C.) ranging from at least about 0.8 to about 1.0 deciliters per gram.

In a further aspect, the polyester composition has a weight average molecular weight from about 5,000 to about 130,000 g/mol as determined by gel permeation chromatography in chloroform/hexafluoroisopropanol (5:95, volume/volume ratio) at 25° C. using polystyrene standards. In a still further aspect, the polyester has a weight average molecular weight from about 10,000 to about 200,000 g/mol as determined by gel permeation chromatography in chloroform/hexafluoroisopropanol (5:95, volume/volume ratio) at 25° C. using polystyrene standards. In a yet further aspect, the polyester composition has a weight average molecular weight from about 20,000 to about 80,000 g/mol as determined by gel permeation chromatography in chloroform/hexafluoroisopropanol (5:95, volume/volume ratio) at 25° C. using polystyrene standards. In an even further aspect, the polyester composition has a weight average molecular weight from about 40,000 to about 70,000 g/mol as determined by gel permeation chromatography in chloroform/hexafluoroisopropanol (5:95, volume/volume ratio) at 25° C. using polystyrene standards. In a still further aspect, the polyester composition has a weight average molecular weight from about 60,000 to about 100,000 g/mol as determined by gel permeation chromatography in chloroform/hexafluoroisopropanol (5:95, volume/volume ratio) at 25° C. using polystyrene standards.

In a further aspect, the polyester composition has a Tg ranging from about 105 to about 150, including exemplary Tg of 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, and 139° C.

In a further aspect, the polyester compositions are substantially transparent. In a further aspect, the polyester compositions can exhibit a level of transmittance that is greater than 50%, including exemplary transmittance values of at least 60%, 70%, 80%, 85%, 90%, and 95%, or any range of transmittance values derived from the above exemplified values. In a still further aspect, the polyester compositions exhibit relatively high levels of transparency characterized by exhibiting a transmittance of at least 80%. In a yet further aspect, the transparency can be measured for a disclosed polymer composition according to ASTM method D1003.

In a further aspect, the polyester compositions have a carboxylic end group content of less than about 100 mEq/kg, including values of less than about 90, 80, 70, 60, 50, 60, 50, 30, 20, and 10 mEq/kg. In a still further aspect, the polyester compositions have a carboxylic end group content of greater than 0 to about 100 mEq/kg, for example, from about 10 to about 100 mEq/kg.

In a further aspect, the polyester compositions preferably exhibit a level of “haze” that is less than 80%, including haze values of less than 70%, 60%, 50%, 40%, 30%, 20%, 10%, 5%, and 1%, or any range derived from these values. In a still further aspect, the polyester compositions exhibit relatively low levels of haze characterized by exhibiting a “haze” value that is less than 20%. In a yet further aspect, haze can be measured for a disclosed polymer composition according to ASTM method D1003.

In a further aspect, the polyester composition is an amorphous copolyester. In a still further aspect, the polyester composition does not exhibit a crystalline melting point as determined by differential scanning calorimetry (DSC). In a yet further aspect, the polyester composition does not exhibit a crystalline melting point having an enthalpy of less than about 1 J/gm.

In one aspect, the present disclosure provides a polyester composition comprising the reaction product of: a) a precursor component comprising xanthene dicarboxylic acid (XDA), or xanthene ester, or a combination thereof; b) a terephthalate component comprising dimethyl terephthalate; and c) a diol component comprising 1,4-cyclohexane dimethanol (CHDM); wherein the polyester composition exhibits a Tg of at least about 105° C., and wherein the polyester composition exhibits an intrinsic viscosity of at least about 0.7 dl/g.

In one aspect, the present disclosure provides a polyester composition comprising the reaction product of: a) a precursor component comprising xanthene dicarboxylic acid (XDA); b) a terephthalate component comprising dimethyl terephthalate; and c) a diol component comprising 1,4-cyclohexane dimethanol (CHDM); wherein the polyester composition exhibits a Tg of at least about 105° C., and wherein the polyester composition exhibits an intrinsic viscosity of at least about 0.7 dl/g.

In one aspect, the present disclosure provides a polyester composition comprising the reaction product of: a) a precursor component comprising a xanthene dicarboxylic acid (XDA), or a reactive derivative thereof; b) a terephthalate component comprising diethyl terephthalate; and c) a diol component comprising 1,4-cyclohexane dimethanol (CHDM); wherein the polyester composition exhibits a Tg of at least about 105° C., and wherein the polyester composition exhibits an intrinsic viscosity of at least about 0.7 dl/g.

In one aspect, the present disclosure provides a polyester composition comprising the reaction product of: a) a precursor component comprising xanthene dicarboxylic acid (XDA), or a reactive derivative thereof; b) a terephthalate component comprising diethyl terephthalate; c) a diol component comprising 1,4-cyclohexane dimethanol (CHDM); and d) at least one metal catalyst present in and amount of from about 50 ppm to about 300 ppm; wherein the polyester composition exhibits a Tg of at least about 105° C.; wherein the polyester composition exhibits an intrinsic viscosity of at least about 0.7 dl/g; and wherein the polyester composition has a lead content of less than about 10 ppm.

In one aspect, the present disclosure provides a polyester composition comprising the reaction product of: a) a precursor component comprising xanthene dicarboxylic acid (XDA), or a reactive derivative thereof; b) a terephthalate component comprising dimethyl terephthalate; c) a diol component comprising 1,4-cyclohexane dimethanol (CHDM); and d) at least one metal catalyst present in and amount of from about 50 ppm to about 300 ppm; wherein the polyester composition exhibits a Tg of at least about 105° C.; wherein the polyester composition exhibits an intrinsic viscosity of at least about 0.7 dl/g; and wherein the polyester composition has a lead content of less than about 10 ppm.

In one aspect, the present disclosure provides a polyester composition comprising the reaction product of: a) a precursor component comprising a xanthene dicarboxylic acid (XDA); b) a terephthalate component comprising diethyl terephthalate; c) a diol component comprising 1,4-cyclohexane dimethanol (CHDM); and d) at least one metal catalyst present in and amount of from about 50 ppm to about 300 ppm; wherein the polyester composition exhibits a Tg of at least about 105° C.; wherein the polyester composition exhibits an intrinsic viscosity of at least about 0.7 dl/g; and wherein the polyester composition has a lead content of less than about 10 ppm.

In one aspect, the present disclosure provides a polyester composition comprising the reaction product of: a) a precursor component comprising xanthene ester, or reactive derivative thereof; b) a terephthalate component comprising dimethyl terephthalate; c) a diol component comprising 1,4-cyclohexane dimethanol (CHDM); and d) at least one metal catalyst present in and amount of from about 50 ppm to about 300 ppm; wherein the polyester composition exhibits a Tg of at least about 105° C.; wherein the polyester composition exhibits an intrinsic viscosity of at least about 0.7 dl/g; and wherein the polyester composition has a lead content of less than about 10 ppm.

In one aspect, the present disclosure provides a polyester composition comprising the reaction product of: a) a precursor component comprising xanthene ester, or reactive derivative thereof; b) a terephthalate component comprising diethyl terephthalate; c) a diol component comprising 1,4-cyclohexane dimethanol (CHDM); and d) at least one metal catalyst present in and amount of from about 50 ppm to about 300 ppm; wherein the polyester composition exhibits a Tg of at least about 105° C.; wherein the polyester composition exhibits an intrinsic viscosity of at least about 0.7 dl/g; and wherein the polyester composition has a lead content of less than about 10 ppm.

In various aspects, the present disclosure also relates to thermoplastic compositions comprising the disclosed polyester compositions. In further aspects, polyester compositions of the present disclosure are useful as a component in thermoplastic compositions.

According to aspects of the disclosure, the thermoplastic composition is a polymer blend. In a further aspect, the polymer blend comprises a) a first polymer component comprising at least one polyester composition described in the present disclosure; and b) a second polymer component. In a still further aspect, the second polymer component comprises one or more of at least one polycarbonate, polyester, styrene acrylonitrile, acrylonitrile butadiene styrene, methyl methacrylate, methacrylate butadiene styrene, styrene maleic anhydride, styrene butadiene styrene, styrene ethylene butadiene styrene, polystyrene, polyolefin, polyetherimide, or a combination thereof.

In one aspect, the polyester composition can be present in the thermoplastic composition in an amount from 20 to 99.99 wt. %, or from 20 to 95 wt. %, or from 30 to 80 wt. %, based on the total weight of the composition, including exemplary wt. % of at least 50 wt. %, at least 60 wt. %, at least 70 wt. %, of the copolyester can be present. In a further aspect, the polyester composition is present in an amount from 50 to 99 wt. %, based on the total weight of the thermoplastic composition, including exemplary wt. % ranges of from 60 to 98 wt. %, and 70 to 95 wt. %, each amount based on the total weight of the thermoplastic composition. The remaining components of the thermoplastic compositions can be other additives, including other polymers, as described below.

In a further aspect, the thermoplastic composition can optionally comprise other polyesters and/or other polymers, for example, other polyesters or polycarbonates. As used herein, “polyesters” is inclusive of homopolymers and copolymers comprising ester units, and “polycarbonate” is inclusive of homopolymers and copolymers comprising carbonate units. Exemplary polyesters include poly(ethylene terephthalate) (“PET”), poly(1,4-butylene terephthalate), (“PBT”), poly(ethylene naphthalate) (“PEN”), poly(butylene naphthalate), (“PBN”), poly(1,3-propylene terephthalate) (“PPT”), poly(cyclohexane-1,4-dimethylene terephthalate) (“PCT”), poly(cyclohexane-1,4-dimethylene cyclohexane-1,4-dicarboxylate) also known as poly(1,4-cyclohexane-dimethanol 1,4-dicarboxylate) (“PCCD”), and poly(cyclohexylene-1,4-dimethylene-co-ethylene terephthalate), also known as cyclohexanedimethanol-terephthalic acid-ethylene glycol (“PCTG” or “PETG”) copolymers. When the molar proportion of cyclohexanedimethanol is higher than that of ethylene glycol the polyester is termed PCTG. When the molar proportion of ethylene glycol is higher than that of cyclohexane dimethanol the polyester is termed PETG. As is known in the art, the foregoing polyesters can further comprise units comprising isophthalic acid. Combinations of the foregoing polymers can be used. The other polymer can be present in an amount of from 0.01 to 80 wt. %, or from 5 to 80 wt. %, or from 30 to 70 wt. %, each based on the total weight of the polyester and the other polymers in the thermoplastic composition. For example, in one aspect, a thermoplastic composition can comprise copolyester produced from the combination of the precursor component (a), the terephthalate component (b), and 1,4-cyclohexane dimethanol (CHDM) (c), can comprise from 1 to 80 wt. % percent, or from 5 to 80 wt. %, or from 30 to 70 wt. %, based on the total weight of the polyesters and other polymers in the thermoplastic composition, of a second polyester, for example poly(ethylene terephthalate), poly(ethylene naphthalate), poly(1,4-butylene naphthalate), poly(trimethylene terephthalate), poly(1,4-cyclohexanedimethylene 1,4-cyclohexanedicarboxylate), poly(1,4-cyclohexanedimethylene terephthalate), poly(1,4-butylene-co-1,4-but-2-ene diol terephthalate), poly(1,4-cyclohexanedimethylene-co-ethylene terephthalate), or a combination comprising at least one of the foregoing polyesters. In other aspects, the thermoplastic composition can comprise 1 to 50 wt. %, or 1 to 30 wt. %, or 1 to 10 wt. %, based on the total weight of the polyester and other polymers in the composition, of a polycarbonate and/or an aromatic copolyester carbonate. In further aspects, the polymer component of the thermoplastic composition consists only of the copolyester. In other aspects, the polymer component comprises at least 70 wt. % of the copolyester. In some aspects, the other polymer includes one or more impact modifiers. The thermoplastic composition can thus comprise the copolyester and optionally, an impact modifier.

In further aspects, the thermoplastic composition comprises at least one additive. In one aspect, the thermoplastic composition can optionally further comprise an impact modifier in an amount from 0.25 to 40 wt. %, including exemplary ranges of from 0.5 to 25 wt. %, or from 1 to 10 wt. %, based on the total weight of the composition. In further aspects, the impact modifier is present in an amount from 0.5 to 8 wt. %, including exemplary ranges of from 1.0 to 6 wt. %, or 0 to 1.0 wt. %, based on the total weight of the composition. In some aspects, the thermoplastic composition does not include an impact modifier or does not contain appreciable amounts of an impact modifier. In other aspects, the impact modifier is present in an amount, based on wt. %, ranging from 0 to less than an integer selected from the group consisting of 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, 1 wt. %, and combinations thereof.

Exemplary and non-limiting impact modifiers include olefin-containing copolymers such as olefin acrylates and olefin diene terpolymers. An example of an olefin acrylate copolymer impact modifier is ethylene ethylacrylate copolymer available from Union Carbide as DPD-6169. Other higher olefin monomers can be employed as copolymers with alkyl acrylates, for example, propylene and n-butyl acrylate. Olefin diene terpolymers known in the art and generally fall into the EPDM (ethylene propylene diene monomer) family of terpolymers. They are commercially available such as, for example, EPSYN® 704 from Copolymer Rubber Company. Examples of such rubber polymers and copolymers that can be used as impact modifiers are polybutadiene, polyisoprene, and various other polymers or copolymers having a rubbery dienic monomer, for example, random copolymers of styrene and butadiene (SBR).

In further aspects, other thermoplastic impact modifiers are unit copolymers, for example, A-B diblock copolymers and A-B-A triblock copolymers having of one or two alkenyl aromatic units A, which are typically styrene units, and a rubber unit, B, which is typically an isoprene or butadiene unit. The butadiene unit may be partially hydrogenated. Mixtures of these diblock and triblock copolymers are especially useful. Examples of A-B and A-B-A copolymers include polystyrene-polybutadiene, polystyrene-poly(ethylene-propylene), polystyrene-polyisoprene, poly(α-methylstyrene)-polybutadiene, polystyrene-polybutadiene-polystyrene (SBS), polystyrene-poly(ethylene-propylene)-polystyrene, polystyrene-polyisoprene-polystyrene and poly(alpha-methylstyrene)-polybutadiene-poly(alpha-methylstyrene), as well as the selectively hydrogenated versions thereof, and the like. Mixtures of the aforementioned unit copolymers are also useful. Styrene-containing polymers can also be used as impact modifiers.

In some aspects, other copolymers containing vinyl aromatic compounds, for example styrene, para-methyl styrene, or alpha methyl styrene and vinyl cyanides, for example acrylonitrile or methacrylonitrile, may also be useful as impact modifiers. One example is styrene-acrylonitrile (SAN), comprising 15 to 30 percent by weight acrylonitrile (AN) with the remainder styrene. The SAN may be further modified by grafting to a rubbery substrate such as a 1,4-polybutadiene to produce a rubber graft polymer, e.g., acrylonitrile-butadiene-styrene (ABS), and methacrylonitrile-butadiene-styrene (MBS). High rubber content (greater than about 50 wt. %) resins of this type (e.g., HRG-ABS) may be especially useful

In further aspects, these types of polymers are often available as core-shell polymers. The core usually consists substantially of an acrylate rubber or a butadiene rubber, wherein one or more shells have been grafted on the core. Usually these shells are built up from a vinyl aromatic compound, a vinyl cyanide, an alkyl acrylate or methacrylate, acrylic acid, methacrylic acid, or a combination of the foregoing. The core and/or the shell(s) often comprise multi-functional compounds that may act as a cross-linking agent and/or as a grafting agent. These polymers are usually prepared in several stages. In still further aspects, other impact modifiers include various elastomeric materials such as organic silicone rubbers, elastomeric fluorohydrocarbons, elastomeric polyesters, random unit polysiloxane-polycarbonate copolymers, and the like.

Exemplary and non-limiting examples of useful impact modifiers include acrylonitrile-butadiene-styrene, methacrylate-butadiene-styrene, high impact polystyrene, and combinations thereof.

In further aspects, the thermoplastic composition, in addition to the polyester composition, can optionally comprise a balance amount of one or more additive materials ordinarily incorporated in thermoplastic resin compositions of this type, with the proviso that the additives are selected so as to not significantly adversely affect the desired properties of the composition. Combinations of additives can be used. Such additives can be mixed at a suitable time during the mixing of the components for forming the composition. Exemplary and non-limiting examples of additive materials that can be present in the disclosed compositions include additional reinforcing fillers, an acid scavenger, anti-drip agent, antioxidant, antistatic agent, chain extender, colorant (e.g., pigment and/or dye), de-molding agent, flow promoter, lubricant, mold release agent, plasticizer, quenching agent, flame retardant stabilizer (including for example a thermal stabilizer, a hydrolytic stabilizer, or a light stabilizer), UV absorbing additive, and UV reflecting additive, or any combination thereof. In a further aspect, the additive is selected from an antioxidant, antistatic agent, chain extender, colorant, de-molding agent, dye, flow promoter, flow modifier, light stabilizer, lubricant, mold release agent, pigment, quenching agent, thermal stabilizer, UV absorbent substance, UV reflectant substance, and UV stabilizer, or combinations thereof.

In a further aspect, the thermoplastic compositions can further comprise a primary antioxidant or “stabilizer” (e.g., a hindered phenol) and, optionally, a secondary antioxidant (e.g., a phosphate and/or thioester). Suitable antioxidant additives include, for example, organic phosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

In a further aspect, the antioxidant is a primary antioxidant, a secondary antioxidant, or combinations thereof. In a still further aspect, the primary antioxidant is selected from a hindered phenol and secondary aryl amine, or a combination thereof. In yet a further aspect, the hindered phenol comprises one or more compounds selected from triethylene glycol bis[3-(3-t-butyl-5-methyl-4-hydroxyphenyl)propionate], 1,6-hexanediolbis[3-(3,5-di-t-butyl-4-hydroxyphenyl)propionate], 2,4-bis(n-octylthio)-6-(4-hydroxy-3,5-di-t-butylanilino)-1,3,5-triazine, pentaerythrityl tetrakis[3-(3,5-di-t-butyl-4-hydroxyphenyl)propionate], 2,2-thiodiethylene bis[3-(3,5-di-t-butyl-4-hydroxyphenyl)propionate], octadecyl 3-(3,5-di-t-butyl-4-hydroxyphenyl)propionate, N,N′-hexamethylene bis(3,5-di-t-butyl-4-hydroxy-hydrocinnamamide), tetrakis(methylene 3,5-di-tert-butyl-hydroxycinnamate)methane, and octadecyl 3,5-di-tert-butylhydroxyhydrocinnamate. In an even further aspect, the hindered phenol comprises octadecyl-3-(3,5-di-t-butyl-4-hydroxyphenyl)-propionate.

In a further aspect, the secondary anti-oxidant is selected from an organophosphate and thioester, or a combination thereof. In a still further aspect, the secondary anti-oxidant comprises one or more compounds selected from tetrakis(2,4-di-tert-butylphenyl) [1,1-biphenyl]-4,4′-diylbisphosphonite, tris(2,4-di-tert-butylphenyl)phosphite, bis(2,4-di-tert-butylphenyl)pentaerythritol diphosphite, bis(2,4-dicumylphenyl)pentaerytritoldiphosphite, tris(nonyl phenyl)phosphite, and distearyl pentaerythritol diphosphite. In yet a further aspect, the secondary anti-oxidant comprises tris(2,4-di-tert-butylphenyl)phosphite.

Antioxidants are generally used in amounts of about 0.01 wt % to about 3 wt %, optionally about 0.05 wt % to about 2.0 wt % of the thermoplastic composition.

In a further aspect, the primary antioxidant is present in an amount from about 0.01 wt % to about 3 wt %. In another aspect, the primary antioxidant is present in an amount from about 0.01 wt % to about 2.5 wt %. In still another aspect, the primary antioxidant is present in an amount from about 0.5 wt % to about 2.5 wt %. In yet a further aspect, the primary antioxidant is present in an amount from about 0.5 wt % to about 2.0 wt %. In still another aspect, the primary antioxidant is present in an amount from about 0.1 wt % to about 0.5 wt %. In still another aspect, the primary antioxidant is present in an amount from about 0.2 wt % to about 0.5 wt %. In still another aspect, the primary antioxidant is present in an amount from about 0.2 wt % to about 0.4 wt %. In a yet further aspect, the primary anti-oxidant is present in an amount from about 0.01 wt % to about 0.50 wt %. In an even further aspect, the primary anti-oxidant is present in an amount from about 0.05 wt % to about 0.25 wt %.

In a further aspect, the secondary antioxidant is present in an amount from about 0.01 wt % to about 3.0 wt %. In another aspect, the secondary antioxidant is present in an amount from about 0.01 wt % to about 2.5 wt %. In still another aspect, the secondary antioxidant is present in an amount from about 0.5 wt % to about 2.5 wt %. In yet another aspect, the secondary antioxidant is present in an amount from about 0.5 wt % to about 2.0 wt %. In still another aspect, the secondary antioxidant is present in an amount from about 0.05 wt % to about 0.4 wt %. In still another aspect, the secondary antioxidant is present in an amount from about 0.05 wt % to about 0.2 wt %. In a yet further aspect, the secondary anti-oxidant is present in an amount from about 0.01 wt % to about 0.50 wt %. In an even further aspect, the secondary anti-oxidant is present in an amount from about 0.05 wt % to about 0.25 wt %.

In various aspects, the thermoplastic composition can further comprise a hydrolytic stabilizer, wherein the hydrolytic stabilizer comprises a hydrotalcite and an inorganic buffer salt. In a further aspect, the thermoplastic composition comprises a hydrolytic stabilizer, wherein the hydrolytic stabilizer comprises one or more hydrotalcites and an inorganic buffer salt comprising one or more inorganic salts capable of pH buffering. Either synthetic hydrotalcites or natural hydrotalcites can be used as the hydrotalcite compound in the present disclosure. Exemplary hydrotalcites that are useful in the compositions of the present are commercially available and include, but are not limited to, magnesium hydrotalcites such as DHT-4C (available from Kyowa Chemical Co.); Hysafe 539 and Hysafe 530 (available from J.M. Huber Corporation).

In a further aspect, suitable thermal stabilizer additives include, for example, organic phosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, organic phosphates such as trimethyl phosphate, thioesters such as pentaerythritol betalaurylthiopropionate, and the like, or combinations comprising at least one of the foregoing thermal stabilizers.

Thermal stabilizers are generally used in amounts of about 0.01 wt % to about 5 wt %, optionally about 0.05 wt % to about 2.0 wt % of the composition. In one aspect, the thermal stabilizer is present in an amount from about 0.01 wt % to about 3.0 wt %. In another aspect, the thermal stabilizer is present in an amount from about 0.01 wt % to about 2.5 wt %. In still another aspect, the thermal stabilizer is present in an amount from about 0.5 wt % to about 2.5 wt %. In still another aspect, the thermal stabilizer is present in an amount from about 0.5 wt % to about 2.0 wt %. In still another aspect, the thermal stabilizer is present in an amount from about 0.1 wt % to about 0.8 wt %. In still another aspect, the thermal stabilizer is present in an amount from about 0.1 wt % to about 0.7 wt %. In still another aspect, the thermal stabilizer is present in an amount from about 0.1 wt % to about 0.6 wt %. In still another aspect, the thermal stabilizer is present in an amount from about 0.1 wt % to about 0.5 wt %. In still another aspect, the thermal stabilizer is present in an amount from about 0.1 wt % to about 0.4 wt %. In still another aspect, the thermal stabilizer is present in an amount from about 0.05 wt % to about 1.0 wt %.

In various aspects, the UV additive can comprise hindered amines Hindered amines are used to make the ultraviolet radiation stable in the polymer compositions. The sterically hindered amine (HALS) are blended into the polymer compositions described herein and have the structure of Formula:

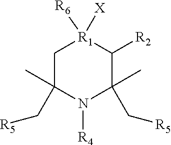

wherein R¹ is C, X is H, and R² is H; wherein R.sub.4 is selected from hydrogen, oxyl, hydroxyl, alkyl of 1 to 20 carbons, alkenyl or alkynyl of 3 to 8 carbons, aralkyl of 7 to 12 carbons, aliphatic acyl of 1 to 10 carbons, aromatic acyl of 7 to 13 carbons, alkoxycarbonyl of 2 to 9 carbons, aryloxycarbonyl of 7 to 15 carbons, alkyl, aryl, cycloalkyl or aralkyl substituted carbamoyl of 2 to 13 carbons, hydroxyalkyl of 1 to 5 carbons, 2-cyanoethyl, epoxyalkyl of 3 to 10 carbons, or a polyalkylene oxide group of 4 to 30 carbons; R.5 is selected from hydrogen or alkyl of 1 to 4 carbons; R6 is selected from hydrogen, hydroxyl, alkoxy of 1 to 4 carbons,

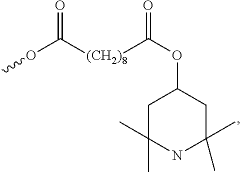

when R₆ is hydrogen, X is a divalent radical selected from —Z—R₇—C(═O)—N(R₈)—, —Z—C(═O)—N(R₈)—, —Z—C(═O)—R₉—C(═O)—N(R₈)—, —R₇—C(═O)—N(R₈)—, or —(═O)—N(R₈)—, Z is —O—, —N(R₁₀)—, or —N(R₁₂)—R11-N(R₁₂)—; when R₆ is hydroxyl or alkoxy, X is a divalent radical selected from —R7-C(═O)—N(R8)- or —C(═O)—N(R8)-, R7 is an alkylene diradical of 1 to 4 carbons, R8 is selected from hydrogen, primary or secondary alkyl of 1 to 8 carbons, aralkyl of 7 to 12 carbons, or cycloalkyl of 5 to 12 carbons, R9 is selected from a direct bond or the following substituted or unsubstituted radicals of alkylene of 1 to 14 carbons, oxydialkylene of 4 to 10 carbons, thiodialkylene of 4 to 10 carbons, alkenylene of 2 to 10 carbons, o, m, or p-phenylene, wherein the substituents for R9 are selected from lower alkyl, lower alkoxy, hydroxy, bromine, chlorine, mercapto, or lower alkylmercapto; R10 and R12 are selected from hydrogen, alkyl of 1 to 10 carbons, aryl of 6 to 12 carbons, aralkyl of 7 to 12 carbons, and cycloalkyl of 5 to 12 carbons, R10 may be a radical of 2-cyanoethyl radical or the formula; R11 is alkylene of 2 to 12 carbons.

HALS bearing reactive hydrazide include the following: 3-(2,2,6,6-tetramethyl-4-piperidinylamino)propionhydrazide, 3-(1,2,2,6,6-pentamethyl-4-piperidinylamino)propionhydrazide, (2,2,6,6-tetramethyl-4-piperidinylamino)acetylhydrazide, (1,2,2,6,6-pentamethyl-4-piperidinylamino)acetylhydrazide, N-(2,2,6,6-tetramethyl-4-piperidinyl)hydrazinecarboxamide, N-(1,2,2,6,6-pentamethyl-4-piperidinyl)hydrazinecarboxamide, N-(2,2,6,6-tetramethyl-4-piperidinyl)-N′-aminooxamide, N-(1,2,2,6,6-pentamethyl-4-piperidinyl)-N′-aminooxamide, N-(2,2,6,6-tetramethyl-4-piperidinyl)-N′-aminosuccinamide, N-(1,2,2,6,6-pentamethyl-4-piperidinyl)-N′-aminosuccinamide, N-(2,2,6,6-tetramethyl-4-piperidinyl)-N′-aminomalonamide, N-(1-benzyl-2,2,6,6-tetramethyl-4-piperidinyl)-N′-aminomalonamide, N-(1-benzyl-2,2,6,6-tetramethyl-4-piperidinyl)-N′-aminooxamide, N-(1-beta-hydroxyethyl-2,2,6,6-tetramethyl-4-piperidinyl)-N′-aminooxamide, N-(2,6-diethyl-2,3,6-trimethyl-4-piperidinyl)-N′-aminoadipamide, N-(1-acetyl-2,2,6,6-tetramethyl-4-piperidinyl)-N′-aminooxamide, 3-(1-acetyl-2,2,6,6-tetramethyl-4-piperidinylamino)propionhydrazide, (2,2,6,6-tetramethyl-4-piperidinyloxy)acetyl hydrazide, (1,2,2,6,6-pentamethyl-4-piperidinyloxy)acetylhydrazide, 3-(2,2,6,6-tetramethyl-4-piperidinyloxy)propionhydrazide, 3,(1,2,2,6,6-pentamethyl-4-piperidinyloxy)propionhydrazide, N-(1-acetyl-2,2,6,6-tetramethyl-4-piperidinyl)hydrazinecarboxamide, N-(1-benzoyl-2,2,6,6-tetramethyl-4-piperidinyl)-N′-aminooxamide, 3-(1-benzoyl-2,2,6,6-tetramethyl-4-piperidinylamino)propionhydrazide, N,N-bis-(2,2,6,6-tetramethyl-4-piperidinyl)-N′-aminooxamide, and 3-[N,N-bis-(2,2,6,6-tetramethyl-4-piperidinyl)amino]propionhydrazide.

In a further aspect, the HALS described above act as stabilizers because they are readily oxidized to the nitroxyl radical, which acts as a catalyst for the termination step of the free radical oxidation cycle. These HALS are also good catalysts and are consumed slowly so they greatly increase the stability of polycarbonate which have slow initiation steps and very long kinetic chains for the oxidation cycle.

In a further aspect, the HALS may be added to the polymerization reaction prior to extrusion. The polymerization reaction may include one or more structural HAL units in the presence of one or more copolymers.

In a further aspect, HALS may be present in the composition at a weight percent below 0.5%, below 0.4%, below 0.3%, below 0.2%, below 0.1%, below 0.007%, or below 0.005%. The HALS may be present in the composition at a weight percent below 0.3%. A single HALS compound may have a molecular weight below 3000 g/mol, below 2500 g/mol, below 2000 g/mol, below 1870 g/mol, below 1700 g/mol, below 1600 g/mol, below 1530 g/mol, below 1500 g/mol, below 1000, below 750 g/mol, below 500 g/mol, below 250 g/mol, or below 100 g/mol. The molecular weight, or molecular mass, may be calculated from the structure of the HALS compound.

In a further aspect, the additive can comprise a UV stabilizer for improved performance in UV stabilization. UV stabilizers disperse the UV radiation energy by absorbing the energy through reversible chemical rearrangements such as hydrogen shifts.

In a further aspect, UV stabilizers may be hydroxybenzophenones, hydroxyphenyl benzotriazoles, cyanoacrylates, oxanilides, and hydroxyphenyl triazines. UV stabilizers may include, but are not limited to, poly[(6-morphilino-s-triazine-2,4-diyl)[2,2,6,6-tetramethyl-4-piperidyl)imino]-hexamethylene[(2,2,6,6-tetramethyl-4-piperidyl)imino], 2-hydroxy-4-octloxybenzophenoe (UVINUL® 3008), 6-tert-butyl-2-(5-chloro-2H-benzotriazole-2-yl)-4-methylphenyl (UVINUL® 3026), 2,4-di-tert-butyl-6-(5-chloro-2H-benzotriazole-2-yl)-phenol (UVINUL® 3027), 2-(2H-benzotriazole-2-yl)-4,6-di-tert-pentylphenol (UVINUL® 3028), 2-(2H-benzotriazole-2-yl)-4-(1,1,3,3-tetramethylbutyl)-phenol (UVINUL® 3029), 1,3-bis[(2′cyano-3′,3′-diphenylacryloyl)oxy]-2,2-bis-{[(2′-cyano-3′,3′-diphenylacryloyl)oxy]methyl}-propane (UVINUL® 3030), 2-(2H-benzotriazole-2-yl)-4-methylphenol (UVINUL® 3033), 2-(2H-bezhotriazole-2-yl)-4,6-bis(1-methyl-1-phenyethyl)phenol (UVINUL® 3034), ethyl-2-cyano-3,3-diphenylacrylate (UVINUL® 3035), (2-ethylhexyl)-2-cyano-3,3-diphenylacrylate (UVINUL® 3039), N,N′-bisformyl-N,N′-bis(2,2,6,6-tetramethyl-4-piperidinyl)hexamethylenediamine (UVINUL® 4050H), bis-(2,2,6,6-tetramethyl-4-piperidyl)-sebacate (UVINUL® 4077H), bis-(1,2,2,6,6-pentamethyl-4-piperidyl)-sebacate+methyl-(1,2,2,6,6-pentamethyl-4-piperidyl)-sebacate (UVINUL® 4092H) or combination thereof.

In a further aspect, the UV stabilizer may be benzotriazoles. Benzotriazoles have the general structure of formula:

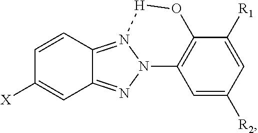

wherein R1 is selected from the group consisting of hydrogen, alkyl, aryl, substituted alkyls, substituted aryls and R2 is selected from the group consisting of hydrogen, alkyl, aryl, substituted alkyls, substituted aryls. Benzotriazoles have absorbance maxima at about 295 nm (ε^{˜}14,000) and 345 nm (ε^{˜}16,000). Benzotriazoles may have a fairly sharp cutoff in absorbance maxima so that there is little tailing into the visible and little yellow color. These compounds may also be substituted adjacent to the hydroxyl group to increase steric hinderance and ensure that the polymer does not contain basic residues that catalyze transesterification with polycarbonates. Exemplary, non-limiting, benzotriazole UV stabilizers include CYASORB® 5411 or TINUVIN® 234.

In a further aspect, the UV stabilizer can be a benzophenone. Benzophenones have the general structure of formula:

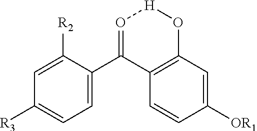

wherein R2 is any one of the following hydrogen, alkyl, aryl, substituted alkyls, substituted aryls and R3 is any one of the following hydrogen, alkyl, aryl, substituted alkyls, substituted aryls. Benzophenones have absorbance maxima at about 285 nm (ε^{˜}15,000) and 325 nm (ε^{˜}10,000). Benzophenones have a long tail in absorbance maxima and create a slightly yellow color in compounds containing benzophenones. The benzophenones may have a 2-hydroxy group and an alkoxy or hydroxyl group in the 4 position. Both of these groups reduce colorization and provide good photostability. The most common derivatives of benzophenones are the 4-methoxy and 4-octyloxy esters. Exemplary, non-limiting, benzophenone UV stabilizers include CYASORB® 24, UVINUL® 3049 and UVINUL® 3050.

In a further aspect, the UV stabilizer can be a cyanoacrylate. Cyanoacrylates have the general structure of formula:

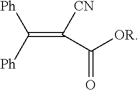

Cyanoacrylates have a single absorbance maximum at about 300 nm (ε^{˜}15,000) resulting in less absorption at longer wavelengths than benzotriazoles or benzophenones. Exemplary, non-limiting, examples of cyanoacrylate UV stabilizers include UVINUL® 3030 and UVINUL® 3059. UVINUL® 3030 is a UV absorber form BASF with the chemical name 1,3-bis-[2′-cyano-3′3-diphenylacryloyl)oxy]-2,2-bis-{[2-cyano-3′,3′-diphenylacryloyboxy]methyl}propan. UVINUL® 5050H is an oligomeric sterically hindered amine from BASF. Its molecular weight is approximately 3500 g/mol.

In a further aspect, the UV stabilizer can be a triazine. Triazines have the general structure of formula:

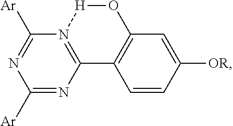

wherein R is an alkyl, substituted alkyl. Triazines have an absorption maxima at 290 nm (ε^{˜}43,000) and at about 340 nm (ε^{˜}23,500). Triazines have a high extinction coefficient and high molecular weights. Exemplary triazine UV stabilizers include, but not limited to TINUVIN® 400, CYASORB® 1164L and TINUVIN® 234.

In a further aspect, the UV stabilizer can be an oxanilide. Oxanilides have the general structure of formula:

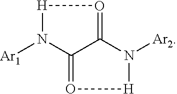

Oxanilides have similar absorption characteristics as cyanoacrylates and may be asymmetrically substituted to broaden the absorption band and improve solubility.

In a further aspect, the antioxidant is a primary antioxidant, a secondary antioxidant, or combinations thereof. In a still further aspect, the primary antioxidant is selected from a hindered phenol and secondary aryl amine, or a combination thereof. In yet a further aspect, the hindered phenol comprises one or more compounds selected from triethylene glycol bis[3-(3-t-butyl-5-methyl-4-hydroxyphenyl)propionate], 1,6-hexanediolbis[3-(3,5-di-t-butyl-4-hydroxyphenyl)propionate], 2,4-bis(n-octylthio)-6-(4-hydroxy-3,5-di-t-butylanilino)-1,3,5-triazine, pentaerythrityl tetrakis[3-(3,5-di-t-butyl-4-hydroxyphenyl)propionate], 2,2-thiodiethylene bis[3-(3,5-di-t-butyl-4-hydroxyphenyl)propionate], octadecyl 3-(3,5-di-t-butyl-4-hydroxyphenyl)propionate, N,N′-hexamethylene bis(3,5-di-t-butyl-4-hydroxy-hydrocinnamamide), tetrakis(methylene 3,5-di-tert-butyl-hydroxycinnamate)methane, and octadecyl 3,5-di-tert-butylhydroxyhydrocinnamate. In an even further aspect, the hindered phenol comprises octadecyl-3-(3,5-di-t-butyl-4-hydroxyphenyl)-propionate.

In various aspects, plasticizers, lubricants, and/or mold release agents additives can also be used. There is a considerable overlap among these types of materials, which include, for example, phthalic acid esters such as dioctyl-4,5-epoxy-hexahydrophthalate; tris(octoxycarbonylethyl)isocyanurate; tristearin; di- or polyfunctional aromatic phosphates such as resorcinol tetraphenyl diphosphate (RDP), the bis(diphenyl)phosphate of hydroquinone and the bis(diphenyl)phosphate of bisphenol-A; poly-alpha-olefins; epoxidized soybean oil; silicones, including silicone oils; esters, for example, fatty acid esters such as alkyl stearyl esters, e.g. methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof; waxes such as beeswax, montan wax, paraffin wax or the like.

Thermoplastic composition additives such as plasticizers, lubricants, and/or mold release agents additive are generally used in amounts of about 0.01 wt % to about 20 wt %, optionally about 0.5 wt % to about 10 wt % the polycarbonate blend composition. In one aspect, the mold release agent is methyl stearate; stearyl stearate or pentaerythritol tetrastearate. In another aspect, the mold release agent is pentaerythritol tetrastearate.

In various aspects, the mold release agent is present in an amount from about 0.01 wt % to about 3.0 wt %. In another aspect, the mold release agent is present in an amount from about 0.01 wt % to about 2.5 wt %. In still another aspect, the mold release agent is present in an amount from about 0.5 wt % to about 2.5 wt %. In still another aspect, the mold release agent is present in an amount from about 0.5 wt % to about 2.0 wt %. In still another aspect, the mold release agent is present in an amount from about 0.1 wt % to about 0.6 wt %. In still another aspect, the mold release agent is present in an amount from about 0.1 wt % to about 0.5 wt %.

In a further aspect, the additive can comprise a phosphorous-containing additive, such as a phosphite or a phosphate. In some aspects, the one or more additive comprises a phosphite. In further aspects, the phosphite comprises a diphenyl alkyl phosphite, phenyl dialkyl phosphite, trialkyl phosphite, dialkyl phosphite, triphenyl phosphite, diphenyl pentaerythritol diphosphite, or any combination thereof. In other aspects, the additive comprises at least one phosphorus compound. In further aspects, the phosphorus compound comprises an aryl phosphate comprising triphenyl phosphate, resorcinol phenyl diphosphate, spirobiindane phenyl diphosphate, di-tertbutyl hydroquinone phenyl diphosphate, biphenol phenyl diphosphate, hydroquinone phenyl diphosphate, or a combination thereof.

According to aspects of the disclosure, the amount of phosphorous-containing compound compounded with the polycarbonate is an amount sufficient to result in the desired effect for which the additive is intended. For example, if the additive is a flame retardant the amount of additive will be that amount sufficient to provide a desired level of flame retardance. Such amounts can be readily determined by one of ordinary skill in the art without undue experimentation. In some aspects, where the phosphorous-containing compound is a phosphite, phosphonate or combination thereof, it is present in an amount in the range of 0.0001 to 2.0 wt %. based on the parts by weight of the polymer composition.

In various aspects, the thermoplastic composition can optionally comprise a flame retardant, wherein the flame retardant can comprise any flame retardant material or mixture of flame retardant materials suitable for use in the inventive polymer compositions. In one aspect, the thermoplastic compositions of the present disclosure do not comprise a flame retardant.

In various aspects, the flame retardant is a phosphorus-containing flame retardant. In a further aspect, the flame retardant is selected from an oligomeric phosphate flame retardant, polymeric phosphate flame retardant, an aromatic polyphosphate flame retardant, oligomeric phosphonate flame retardant, phenoxyphosphazene oligomeric flame retardant, or mixed phosphate/phosphonate ester flame retardant compositions.

In a further aspect, the thermoplastic compositions comprise a flame retardant that is a non-brominated and non-chlorinated phosphorous-containing compound such as an organic phosphate. Exemplary organic phosphates can include an aromatic phosphate of the formula (GO)₃P═O, wherein each G is independently an alkyl, cycloalkyl, aryl, alkaryl, or aralkyl group, provided that at least one G is an aromatic group. Two of the G groups can be joined together to provide a cyclic group, for example, diphenyl pentaerythritol diphosphate, which is described by Axelrod in U.S. Pat. No. 4,154,775. Other suitable aromatic phosphates can be, for example, phenyl bis(dodecyl)phosphate, phenyl bis(neopently)phosphate, phenyl bis(3,5,5′-trimethylhexyl)phosphate, ethyl diphenyl phosphate, 2-ethylhexyl di(p-tolyl)phosphate, bis(2-ethylhexyl)p-tolyl phosphate, tritolyl phosphate, bis(2-ethylhexyl)phenyl phosphate, dibutyl phenyl phosphate, 2-chloroethyl diphenyl phosphate, p-tolyl bis(2,5,5′-trimethylhexyl)phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like.

In a further aspect, di- or polyfunctional aromatic phosphorous-containing compounds can also be present. Examples of suitable di- or polyfunctional aromatic phosphorous-containing compounds include triphenyl phosphate (TPP), resorcinol tetraphenyl diphosphate (RDP), the bis(diphenyl)phosphate of hydroquinone and the bis(diphenyl)phosphate of bisphenol-A, respectively, their oligomeric and polymeric counterparts, and the like.

In a further aspect, the flame retardant can be an organic compounds containing phosphorous-nitrogen bonds. For example, phosphonitrilic chloride, phosphorous ester amides, phosphoric acid amides, phosphonic acid amides, phosphinic acid amides, tris(aziridinyl)phosphine oxide, or the like. In one aspect, a phenoxyphosphazene is used as a flame retardant.

In a further aspect, the phosphorus-containing flame retardant is selected from a phosphine, a phosphine oxide, a bisphosphine, a phosphonium salt, a phosphinic acid salt, a phosphoric ester, and a phosphorous ester.

In a further aspect, the phosphorus-containing flame retardant is selected from rescorcinol bis(diphenyl phosphate), resorcinol bis(dixylenyl phosphate), hydroquinone bis(diphenyl phosphate), bisphenol-A bis(diphenyl phosphate), 4,4′-biphenol bis(diphenyl phosphate), triphenyl phosphate, methylneopentyl phosphite, pentaerythritol diethyl diphosphite, methyl neopentyl phosphonate, phenyl neopentyl phosphate, pentaerythritol diphenyldiphosphate, dicyclopentyl hypodiphosphate, dineopentyl hypophosphite, phenylpyrocatechol phosphite, ethylpyrocatechol phosphate and dipyrocatechol hypodiphosphate. In a still further aspect, the flame retardant is selected from triphenyl phosphate; cresyldiphenylphosphate; tri(isopropylphenyl)phosphate; resorcinol bis(diphenylphosphate); and bisphenol-A bis(diphenyl phosphate). In a yet further aspect, resorcinol bis(biphenyl phosphate), bisphenol A bis(diphenyl phosphate) hydroquinone bis(diphenyl phosphate), phosphoric acid, 1,3-phenylene tetraphenyl ester), bis-phenol-A bis-diphenyl phosphate) or mixtures thereof. In an even further aspect, the flame retardant is bisphenol-A bis(diphenyl phosphate). In a still further aspect, the phosphorus-containing flame retardant is selected from resorcinol bis(biphenyl phosphate), bisphenol A bis(diphenyl phosphate), and hydroquinone bis(diphenyl phosphate), or mixtures thereof. In yet a further aspect, the phosphorus-containing flame retardant is bisphenol A bis(diphenyl phosphate). In an even further aspect, the phosphorus-containing flame retardant is resorcinol bis(biphenyl phosphate).

In a further aspect, the flame retardant is present in an amount from greater than about 0 wt % to about 15 wt %. In a still further aspect, the flame retardant is present in an amount from about 0.01 wt % to about 15 wt %. In a yet further aspect, the flame retardant is present in an amount from about 0.1 wt % to about 15 wt %. In an even further aspect, the flame retardant is present in an amount from about 1 wt % to about 15 wt %.

In a further aspect, the flame retardant is present in an amount from about 1 wt % to about 1 wt %. In a still further aspect, the flame retardant is present in an amount from about 1 wt % to about 13 wt %. In yet a further aspect, the flame retardant is present in an amount from about 1 wt % to about 12 wt %. In an even further aspect, the flame retardant is present in an amount from about 2 wt % to about 12 wt %. In a still further aspect, the flame retardant is present in an amount from about 3 wt % to about 12 wt %. In yet a further aspect, the flame retardant is present in an amount from about 4 wt % to about 12 wt %. In an even further aspect, the flame retardant is present in an amount from about 4 wt % to about 11 wt %. In a still further aspect, the flame retardant is present in an amount from about 4 wt % to about 10 wt %. In yet a further aspect, the flame retardant is present in an amount from about 5 wt % to about 10 wt %. In an even further aspect, the flame retardant is present in an amount from about 6 wt % to about 10 wt %.

In a further aspect, an anti-drip agents can also be present. In a further aspect, the anti-drip agent is a styrene-acrylonitrile copolymer encapsulated polytetrafluoroethylene. Exemplary anti-drip agents can include a fibril forming or non-fibril forming fluoropolymer such as polytetrafluoroethylene (PTFE). The anti-drip agent can optionally be encapsulated by a rigid copolymer, for example styrene-acrylonitrile (SAN). PTFE encapsulated in SAN is known as TSAN. Encapsulated fluoropolymers can be made by polymerizing the encapsulating polymer in the presence of the fluoropolymer, for example, in an aqueous dispersion. TSAN can provide significant advantages over PTFE, in that TSAN can be more readily dispersed in the composition. A suitable TSAN can comprise, for example, about 50 wt % PTFE and about 50 wt % SAN, based on the total weight of the encapsulated fluoropolymer. Alternatively, the fluoropolymer can be pre-blended in some manner with a second polymer, such as for, example, an aromatic polycarbonate resin or SAN to form an agglomerated material for use as an anti-drip agent. Either method can be used to produce an encapsulated fluoropolymer.

In a further aspect, the anti-drip agent is present in an amount from about 0.01 wt % to about 3 wt %. In a still further aspect, the anti-drip agent is present in an amount from about 0.01 wt % to about 2.5 wt %. In yet a further aspect, the anti-drip agent is present in an amount from about 0.5 wt % to about 2.0 wt %.

In various aspects, the thermoplastic compositions of the present disclosure can optionally further comprise reinforcing fillers in addition to one or more glass fiber fillers as described herein above. For example, suitable fillers or reinforcing agents include any materials known for these uses, provided that they do not adversely affect the desired properties. For example, suitable fillers and reinforcing agents include silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dehydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as carbon fibers; sulfides such as molybdenum sulfide, zinc sulfide, or the like; barium compounds such as barium titanate, barium ferrite, barium sulfate, heavy spar, or the like; metals and metal oxides such as particulate or fibrous aluminum, bronze, zinc, copper and nickel, or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as kenaf, cellulose, cotton, sisal, jute, flax, starch, corn flour, lignin, ramie, rattan, agave, bamboo, hemp, ground nut shells, corn, coconut (coir), rice grain husks or the like; organic fillers such as polytetrafluoroethylene, reinforcing organic fibrous fillers formed from high melting organic polymers capable of forming fibers such as poly(ether ketone), polyimide, polybenzoxazole, poly(phenylene sulfide), aromatic polyamides, aromatic polyimides, polytetrafluoroethylene, or the like; as well as additional fillers and reinforcing agents such as mica, clay, feldspar, flue dust, fillite, quartz, quartzite, perlite, Tripoli, diatomaceous earth, carbon black, or the like, or combinations comprising at least one of the foregoing fillers or reinforcing agents. In a still further aspect, the filler is talc, glass fiber, kenaf fiber, or combinations thereof. In yet a further aspect, the filler is glass fiber. In other instances the composition will comprise 3-50 wt % glass fibers with a filament diameter of from 5 to 20 microns. The fillers and reinforcing agents can be coated with a layer of metallic material to facilitate conductivity, or surface treated with silanes, siloxanes, or a combination of silanes and siloxanes to improved adhesion and dispersion with the polymeric matrix resin.

In a further aspect, the additional reinforcing filler is selected from carbon fiber, a mineral filler, or combinations thereof. In a still further aspect, the reinforcing filler is selected from mica, talc, clay, wollastonite, zinc sulfide, zinc oxide, carbon fiber, ceramic-coated graphite, titanium dioxide, or combinations thereof.

In one aspect, the present disclosure provide a thermoplastic composition comprising a polyester composition comprising the reaction product of: a) a precursor component comprising xanthene dicarboxylic acid (XDA), or xanthene ester, or a combination thereof; b) a terephthalate component comprising at least one di(C₁₋₃ alkyl) terephthalate, or terephthalic acid, or a combination thereof; c) a diol component comprising 1,4-cyclohexane dimethanol (CHDM); at least one metal catalyst present in and amount of from about 50 ppm to about 300 ppm; wherein the polyester composition exhibits a Tg of at least about 105° C.; wherein the polyester composition exhibits an intrinsic viscosity of at least about 0.7 dl/g; and wherein the polyester composition has a lead content of less than about 10 ppm.

In one aspect, the present disclosure provides a thermoplastic composition comprising a polyester composition comprising the reaction product of: a) a precursor component comprising xanthene dicarboxylic acid (XDA), or a reactive derivative thereof; b) a terephthalate component comprising diethyl terephthalate; c) a diol component comprising 1,4-cyclohexane dimethanol (CHDM); and d) at least one metal catalyst present in and amount of from about 50 ppm to about 300 ppm; wherein the polyester composition exhibits a Tg of at least about 105° C.; wherein the polyester composition exhibits an intrinsic viscosity of at least about 0.7 dl/g; and wherein the polyester composition has a lead content of less than about 10 ppm.

In one aspect, the present disclosure provides a thermoplastic composition comprising a polyester composition comprising the reaction product of: a) a precursor component comprising xanthene dicarboxylic acid (XDA), or a reactive derivative thereof; b) a terephthalate component comprising dimethyl terephthalate; c) a diol component comprising 1,4-cyclohexane dimethanol (CHDM); and d) at least one metal catalyst present in and amount of from about 50 ppm to about 300 ppm; wherein the polyester composition exhibits a Tg of at least about 105° C.; wherein the polyester composition exhibits an intrinsic viscosity of at least about 0.7 dl/g; and wherein the polyester composition has a lead content of less than about 10 ppm wherein the polyester composition exhibits a Tg of at least about 107° C., and wherein the polyester composition exhibits a intrinsic viscosity of at least about 0.7 dl/g.

### Methods of Manufacture

In one aspect, preparation of polyester compositions of the present disclosure comprise the steps of: a) providing a precursor component comprising xanthene dicarboxylic acid (XDA), xanthene ester, or a combination thereof; b) providing a terephthalate component comprising at least one di(C₁₋₃ alkyl) terephthalate, or terephthalic acid, or a combination thereof; c) a diol component comprising providing 1,4-cyclohexane dimethanol (CHDM); and d) reacting the precursor component, terephthalate component, and diol component under conditions effective to provide a reaction product comprising a polyester, wherein the conditions effective further comprise removing a C₁ to C₃ alcohol or water or a combination thereof. In a further aspect, the conditions effective comprise reacting the precursor component, terephthalate component, and a diol component in the presence of catalyst. In still further aspect, the catalyst comprises at least one metal catalyst selected from antimony compounds, tin compounds, titanium compounds, germanium compounds, zirconium compounds, zinc compounds, or cerium compounds, or combinations thereof.

In one aspect, the C₁ to C₃ alcohol comprises methanol, ethanol, or propanol, or a combination thereof.

In another aspect, thermoplastic compositions comprising polyester compositions of the present disclosure can be prepared with the aforementioned ingredients by a variety of methods involving intimate admixing of the materials with any additional additives desired in the formulation. Because of the availability of melt blending equipment in commercial polymer processing facilities, melt processing methods are generally preferred. Illustrative examples of equipment used in such melt processing methods include: co-rotating and counter-rotating extruders, single screw extruders, co-kneaders, disc-pack processors and various other types of extrusion equipment. The temperature of the melt in the present process is preferably minimized in order to avoid excessive degradation of the resins. It is often desirable to maintain the melt temperature between about 200° C. and about 320° C. in the molten resin composition, although higher temperatures can be used provided that the residence time of the resin in the processing equipment is kept short. In some embodiments the melt processed composition exits processing equipment such as an extruder through small exit holes in a die. The resulting strands of molten resin are cooled by passing the strands through a water bath. The cooled strands can be chopped into small pellets for packaging and further handling.

The disclosed thermoplastic compositions can be manufactured by various methods. For example, the first polymer component comprising a disclosed polyester composition, second polymer component, and/or other optional components are first blended in a HENSCHEL-Mixer® high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming.

### Articles of Manufacture

In one aspect, the present disclosure pertains to shaped, formed, molded, or printed articles comprising the disclosed thermoplastic compositions. The thermoplastic compositions can be molded into useful shaped articles by a variety of means such as injection molding, profile extrusion, rotational molding, blow molding, thermoforming, additive manufacturing, and 3-D printing to form articles such as, for example, personal computers, notebook and portable computers, cell phone antennas and other such communications equipment, medical applications, RFID applications, automotive applications, building and construction materials, housewares, cookware, and the like. In a further aspect, the article is extrusion molded. In a still further aspect, the article is injection molded. In a yet further aspect, the article is additive manufactured. In an even further aspect, the article is 3-D printed.

In various aspects, the polymer composition can be used in the electronics field, automotive field, telecommunication field, building and construction materials, housewares, cookwares, or medical field.

In a further aspect, the article is an electronic device, automotive device, telecommunication device, medical device, security device, or mechatronic device. In a still further aspect, the article is selected from a computer device, electromagnetic interference device, printed circuit, Wi-Fi device, Bluetooth device, GPS device, cellular antenna device, smart phone device, automotive device, medical device, sensor device, security device, shielding device, RF antenna device, LED device, and RFID device.

In certain aspects, the article is selected from a medical device, surgical device, imaging device, monitoring device, drug delivery device, interior trim, window, floor, cover, wall panel, door, enclosure, housing, panel, lighting switch, bedding part, furniture part, culinary device, food preparation device, food storage device, or food delivery device, blow molded bottle or a combination thereof. In other instances the article can be made by injection molding, extrusion molding, or blow molding wherein at least a portion of the article has a wall thickness from 1.0 to 5.0 mm and a percent transmission of greater than or equal to 60%.

In various aspects, molded articles according to the present disclosure can be used to produce a device in one or more of the foregoing fields.

Without further elaboration, it is believed that one skilled in the art can, using the description herein, utilize the present disclosure. The following examples are included to provide addition guidance to those skilled in the art of practicing the claimed disclosure. The examples provided are merely representative of the work and contribute to the teaching of the present disclosure. Accordingly, these examples are not intended to limit the disclosure in any manner.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning comprising grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior disclosure. Further, the dates of publication provided herein can be different from the actual publication dates, which can require independent confirmation.

### Aspects

The present disclosure comprises at least the following aspects.

Aspect 1: A polyester composition comprising the reaction product of: a precursor component comprising a xanthene dicarboxylic acid), a reactive derivative thereof, or a xanthene ester, or a combination thereof; a terephthalate component comprising at least one di(C1-C3 alkyl) terephthalate, or terephthalic acid, or a combination thereof; a diol component comprising 1,4-cyclohexane dimethanol; and at least one metal catalyst present in an amount from about 50 ppm to about 300 ppm, wherein the polyester composition exhibits a glass transition temperature of at least about 105° C., wherein the polyester composition exhibits an intrinsic viscosity of at least about 0.7 dl/g, and wherein the polyester composition has a lead content of less than about 10 ppm.

Aspect 2: The polyester composition of aspect 1, wherein the xanthene dicarboxylic acid comprises 9,9-dimethylxanthene 2,6-dicarboxylic acid; 9,9-dimethylxanthene 2,7-dicarboxylic acid; or 9,9-dimethylxanthene 3,6 dicarboxylic acid; or a combination thereof.

Aspect 3: The polyester composition of any of aspects 1-2, wherein the terephthalate component comprises a di(C1-C3 alkyl) terephthalate.

Aspect 4: The polyester composition of aspect 3, wherein the di(C1-C3 alkyl) terephthalate is selected from diethyl terephthalate or dimethyl terephthalate, or a combination thereof.

Aspect 5: The polyester composition of any of aspects 1-4, wherein the 1,4-cyclohexane dimethanol has an isomer distribution of from about 50% to about 80% trans isomers and from about 20% to about 50% cis isomers.

Aspect 6: The polyester composition of any of aspects 1-5, wherein the 1,4-cyclohexane dimethanol has an isomer distribution of about 70% trans isomers and about 30% cis isomers.

Aspect 7: The polyester composition of any of aspects 1-6, wherein the at least one metal catalyst comprises an antimony compound, a tin compound, a titanium compound, a germanium compound, a zirconium compound, a zinc compound, or a cerium compound, or a combination thereof.

Aspect 8: The polyester composition of any of aspects 1-7, wherein the polyester composition comprises from about 5 mol % to about 30 mol % precursor component units, and from about 70 mol % to about 95 mol % terephthalate component units, wherein the total moles of each component is based on the total moles of precursor component units and terephthalate component units in the polyester composition.

Aspect 9: The polyester composition of any of aspects 1-8, wherein the polyester composition comprises from about 80 mol % to about 95 mol % 1,4-cyclohexane dimethanol, wherein the total moles is based on the total moles of repeating diol units in the polyester composition.

Aspect 10: The polyester composition of any of aspects 1-9, wherein the polyester composition comprises an amorphous copolyester.

Aspect 11: The polyester composition of any of aspects 1-10, wherein the polyester composition does not exhibit a crystalline melting point as determined by differential scanning calorimetry.

Aspect 12: The polyester composition of any of aspects 1-11, wherein the polyester composition does not exhibit a crystalline melting point having an enthalpy of less than about 1 J/gm.

Aspect 13: The polyester composition of any of aspects 1-12, wherein the polyester composition comprises the reaction product of: a precursor component comprising a xanthene dicarboxylic acid or reactive derivative thereof; or a combination thereof; a terephthalate component comprising dimethyl terephthalate; a diol component comprising 1,4-cyclohexane dimethanol; and at least one metal catalyst comprising an antimony compound, a tin compound, a titanium compound, a germanium compound, a zirconium compound, a zinc compound, or a cerium compound, or a combination thereof, present in an amount from about 50 ppm to about 300 ppm, wherein the polyester composition exhibits a glass transition temperature of at least about 105° C.; wherein the polyester composition exhibits an intrinsic viscosity of at least about 0.7 dl/g as measured using ASTM D2857; and wherein the polyester composition has a lead content of less than about 10 ppm.

Aspect 14: The polyester composition of any of aspects 1-13, wherein the polyester composition comprises the reaction product of: a precursor component comprising a xanthene dicarboxylic acid, or a reactive derivative thereof; a terephthalate component comprising diethyl terephthalate; a diol component comprising 1,4-cyclohexane dimethanol; and at least one metal catalyst comprising an antimony compound, a tin compound, a titanium compound, a germanium compound, a zirconium compound, a zinc compound, or a cerium compound, or a combination thereof, present in an amount of from about 50 ppm to about 300 ppm; wherein the polyester composition exhibits a glass transition temperature of at least about 105° C.; wherein the polyester composition exhibits an intrinsic viscosity of at least about 0.7 dl/g; and wherein the polyester composition has a lead content of less than about 10 ppm.

Aspect 15: A polymer blend comprising: a first polymer component comprising at least one polyester composition according to any of aspects 1-14; and a second polymer component.

Aspect 16: The polymer blend of aspect 15, wherein the second polymer component comprises one or more of at least one polycarbonate, polyester, styrene acrylonitrile, acrylonitrile butadiene styrene, methyl methacrylate, methacrylate butadiene styrene, styrene maleic anhydride, styrene butadiene styrene, styrene ethylene butadiene styrene, polystyrene, polyolefin, or polyetherimide, or a combination thereof.

Aspect 17: The polymer blend of aspect 15, further comprising at least one additive including a stabilizer, antioxidant, colorant, impact modifier, flame retardant, anti-drip additive, mold release additive, lubricant, plasticizer, mineral, reinforcement additive, UV additive, or phosphorus-containing additives, or a combination thereof.

Aspect 18: The polymer blend of aspect 15, wherein the polyester composition comprises the reaction product of: a precursor component comprising a xanthene dicarboxylic acid or a reactive derivative thereof, or a combination thereof; a terephthalate component comprising diethyl terephthalate or diethyl terephthalate; a diol component comprising 1,4-cyclohexane dimethanol; and at least one metal catalyst present in an amount from about 50 ppm to about 300 ppm; wherein the polyester composition exhibits a glass transition temperature of at least about 105° C.; wherein the polyester composition exhibits an intrinsic viscosity of at least about 0.7 dl/g as measured using ASTM D2857; and wherein the polyester composition has a lead content of less than about 10 ppm.

Aspect 19: An article comprising the polymer blend of aspect 15.

Aspect 20: The article of aspect 19, wherein the article is a molded article.

Aspect 21: The article of aspect 20, wherein the molded article is injected molded, extrusion molded, or blow molded wherein at least a portion of the article has a wall thickness from about 1.0 to about 5.0 mm and a percent transmission of greater than or equal to 60%.

Aspect 22: A method for preparing a polyester composition, the method comprising: providing a precursor component comprising xanthene dicarboxylic acid, a reactive derivative thereof, or a xanthene ester, or a combination thereof; providing a terephthalate component comprising at least one di(C1-3 alkyl) terephthalate, or terephthalic acid, or a combination thereof; providing a diol component comprising 1,4-cyclohexane dimethanol; and reacting the precursor component, terephthalate component, and diol component under conditions effective to provide a reaction product comprising a polyester; wherein the conditions effective further comprise removing a C1 to C3 alcohol or water or a combination thereof, wherein the polyester exhibits a glass transition temperature of at least about 105° C., and wherein the polyester exhibits an intrinsic viscosity of at least about 0.7 dl/g.

Aspect 23: The method of aspect 22, wherein conditions effective comprise polymerizing the precursor component, terephthalate component, and diol component in the presence of catalyst.

Aspect 24: The method of aspect 23, wherein the catalyst comprises at least one metal catalyst comprising an antimony compound, a tin compound, a titanium compound, a germanium compound, a zirconium compound, a zinc compound, or a cerium compound, or a combination thereof.

Aspect 25: The method of aspect 24, wherein the xanthene ester comprises at least one ester comprising a carbon chain ranging from C1 to C3.

Aspect 26: The method of any of aspects 24-25, wherein the xanthene ester comprises at least one ester and at least one carboxylic acid.

Aspect 27: The method of any of aspects 24-26, wherein the di(C1-3 alkyl) terephthalate is diethyl terephthalate.

### Examples

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable experimentation will be required to optimize such process conditions.

The materials shown in Table 1 were used to prepare the polyester compositions described and evaluated herein.

TABLE 1

| Item | Description | Supplier |
|---|---|---|
| DET | Diethyl terephthalate (DET) | Sigma Aldrich |
| CHDM | 1,4-Cyclohexane dimethanol | Eastman Chemical |
| | (30/70 cis/trans ratio); | Company |
| XDA | 9,9-dimethyl xanthene-3,6- | Prepared using |
| | dicarboxylic acid; | procedure described |
| | | herein |

The examples described herein were tested in accordance with ASTM methods D2857-95 (IV), ASTM 7426-08 (DSC).

Glass transition temperature (Tg) was determined according to ASTM D3418 by Differential Scanning calorimetry (DSC) using Perkin Elmer DSC 7 equipped with Pyris DSC 7 software. In a typical procedure, polymer sample (10-20 mg) was heated from 40° C. to 290° C. (20° C./min), held at 290° C. for 1 min, cooled back to 40° C. (20° C./min), then held at 40° C. for 1 min, and the above heating/cooling cycle was repeated. The second heating cycle is usually used to obtain the Tg data. The DSC scans showed no crystalline melting point. The heat of fusion was not detected and was below 1 J/gm.

Intrinsic viscosity (‘IV’) was determined using an automatic Viscotek Microlab® 500 series Relative Viscometer Y501. In a typical procedure, 0.5000 g of polymer sample was fully dissolved in 60/40 mixture (by vol) of % phenol/1,1,2,2-tetrachloroethane (TCE) solution (Harrell Industries). Two measurements were taken for each sample, and the result reported was the average of the two measurements taken at 23° C. as per ASTM D2857.

Synthesis of 9,9-dimethyl xanthene-3,6-dicarboxylic acid (XDA).

As per U.S. Pat. No. 5,554,770, a 5 g sample of 3,6,9,9-tetramethylxanthene can be charged to a 300 mL stirred pressure reactor with 162 mg Co(OAc)₂ hydrate, 168 mg Mn(OAc)₂ hydrate, 328 mg di-t-butyl peroxide, 326 mg 48% aq.HBr and 160 mL acetic acid. The reactor was sealed and pressurized to approximately 370 psig with oxygen and the temperature was raised to 130 to 160 C for 5 hrs. After cooling, the reactor was vented and the contents filtered on a fritted disc. The resulting off-white solid was washed with water and air dried. The reaction product yield 3.57 g of a cream colored powder. Based on the method of preparation and chemical analysis, the product was 9,9-dimethylxanthene-3,6-dicarboxylic acid, it was further characterized by ¹H-NMR (DMSO-d6) chemical shifts: delta 13.03 (br s, 2H), 7.68 (s, 4H), 7.56 (s, 2H), 1.61 (s, 6H).

Co-polymerization of 9,9-dimethyl xanthene-3,6-dicarboxylic acid (XDA) with cyclohexane dimethanol (CHDM) and diethyl terephthalate (DET).

In an exemplary aspect, a polyester composition of the present disclosure was prepared as follows. A mixture of 23.52 gm of XDA, 95.46 gm of DET, and 74.54 gm of CHDM were introduced into a three neck round bottom flask equipped with a nitrogen inlet, glass stirrer with a metal blade, and a short distillation column. The flask was placed in an oil bath with the stirring speed set at 260 rpm, and adjusted to a temperature of 170° C. 250 ppm of titanium catalyst (tetra isopropyl titanate) was then added to the reaction mixture, and the temperature was gradually increased to 230° C. at a rate of 2° C./minute while stirring under nitrogen with removal of ethanol and water. The reaction mixture was heated at 230° C. Following completion of the ester interchange, the temperature of reaction was increased to 290° C. at a rate of 2° C./minute. After the reaction temperature reached 290° C., pressure inside the reactor was gradually reduced to 0.2 mm Hg (less than 1 torr) to build a high intrinsic viscosity. With the vacuum adjusted to below 1 torr, the polymerization stage was continued for 1 hour. A pressure of less than 1 torr was maintained for a total time of 60 minutes. At the end of the polymerization stage, the vacuum was stopped and product was collected under nitrogen flow for analysis. In the synthesis of polyesters such as these with higher boiling diols such as CHDM, and other diols with 8 or more carbon atoms, it is much more important to control diol/diester-diacid stoichiometry than it is with lower diols (4 carbon atoms or less). In the synthesis of polyesters using such lower diols (such as PBT and PET) an excess of diol can be employed, the excess then removed as polymer IV builds keeping the diester/diacid content intact. In polyesters made with the higher boiling diols such as CHDM such removal of excess higher boiling diol may also cause loss of diester such as dimethyl terephthalate (DMT). In our process we use diethyl terephthalate (DET) which boils at 302° C. (at atmospheric pressure) rather than DMT which has a lower boiling point (288° C.). While use of DMT can allow the build of higher IV resin the DET makes the polymerization process easier and more efficient especially when vacuum is employed. The XDA-CHDM copolyester sample had less than 1 ppm lead and showed no crystalline melting point by DSC. The XDA-CHDM copolymer had Tg of 109° C. with an IV of 0.75 dl/g. The copolymer was clear, a pressed film having a percent transmission (% T) of >60% at 1 mm. The film also showed good flexibility and toughness. The inventive polymer composition derived of repeating units comprising the reaction product of XDA, dialkyl terephthalate and cyclohexane dimethanol (CHDM), exhibited the useful combination of a Tg of at least 105° C., and an intrinsic viscosity (IV) of at least 0.7 dl/g. As the data suggest, the inventive polyester composition exhibits the ideal combination of high glass transition temperature and good flow.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A polyester composition comprising the reaction product of:
a) a precursor component comprising a xanthene dicarboxylic acid), a reactive derivative thereof, or a xanthene ester, or a combination thereof;
b) a terephthalate component comprising at least one di(C1-C3 alkyl) terephthalate, or terephthalic acid, or a combination thereof;
c) a diol component comprising 1,4-cyclohexane dimethanol; and
d) at least one metal catalyst present in an amount from about 50 ppm to about 300 ppm,
wherein the polyester composition exhibits a glass transition temperature of at least about 105° C., wherein the polyester composition exhibits an intrinsic viscosity of at least about 0.7 dl/g, and wherein the polyester composition has a lead content of less than about 10 ppm.

2. The polyester composition of claim 1, wherein the xanthene dicarboxylic acid comprises 9,9-dimethylxanthene 2,6-dicarboxylic acid; 9,9-dimethylxanthene 2,7-dicarboxylic acid; or 9,9-dimethylxanthene 3,6 dicarboxylic acid; or a combination thereof.

3. The polyester composition of claim 1, wherein the terephthalate component comprises a di(C1-C3 alkyl) terephthalate.

4. The polyester composition of claim 3, wherein the di(C1-C3 alkyl) terephthalate is selected from diethyl terephthalate or dimethyl terephthalate, or a combination thereof.

5. The polyester composition of claim 1, wherein the 1,4-cyclohexane dimethanol has an isomer distribution of from about 50% to about 80% trans isomers and from about 20% to about 50% cis isomers.

6. The polyester composition of claim 1, wherein the 1,4-cyclohexane dimethanol has an isomer distribution of about 70% trans isomers and about 30% cis isomers.

7. The polyester composition of claim 1, wherein the at least one metal catalyst comprises an antimony compound, a tin compound, a titanium compound, a germanium compound, a zirconium compound, a zinc compound, or a cerium compound, or a combination thereof.

8. The polyester composition of claim 1, wherein the polyester composition comprises from about 5 mol % to about 30 mol % precursor component units, and from about 70 mol % to about 95 mol % terephthalate component units, wherein the total moles of each component is based on the total moles of precursor component units and terephthalate component units in the polyester composition.

9. The polyester composition of claim 1, wherein the polyester composition comprises from about 80 mol % to about 95 mol % 1,4-cyclohexane dimethanol,
wherein the total moles is based on the total moles of repeating diol units in the polyester composition.

10. The polyester composition of claim 1, wherein the polyester composition comprises an amorphous copolyester.

11. The polyester composition of claim 1, wherein the polyester composition does not exhibit a crystalline melting point as determined by differential scanning calorimetry.

12. The polyester composition of claim 1, wherein the polyester composition does not exhibit a crystalline melting point having an enthalpy of less than about 1 J/gm.

13. The polyester composition of claim 1, wherein the polyester composition comprises the reaction product of:
a) a precursor component comprising a xanthene dicarboxylic acid or reactive derivative thereof; or a combination thereof;
b) a terephthalate component comprising dimethyl terephthalate;
c) a diol component comprising 1,4-cyclohexane dimethanol; and
d) at least one metal catalyst comprising an antimony compound, a tin compound, a titanium compound, a germanium compound, a zirconium compound, a zinc compound, or a cerium compound, or a combination thereof, present in an amount from about 50 ppm to about 300 ppm;
wherein the polyester composition exhibits a glass transition temperature of at least about 105° C.; wherein the polyester composition exhibits an intrinsic viscosity of at least about 0.7 dl/g as measured using ASTM D2857; and
wherein the polyester composition has a lead content of less than about 10 ppm.

14. The polyester composition of claim 1, wherein the polyester composition comprises the reaction product of:
a) a precursor component comprising a xanthene dicarboxylic acid, or a reactive derivative thereof;
b) a terephthalate component comprising diethyl terephthalate;
c) a diol component comprising 1,4-cyclohexane dimethanol; and
d) at least one metal catalyst comprising an antimony compound, a tin compound, a titanium compound, a germanium compound, a zirconium compound, a zinc compound, or a cerium compound, or a combination thereof, present in an amount of from about 50 ppm to about 300 ppm;
wherein the polyester composition exhibits a glass transition temperature of at least about 105° C.; wherein the polyester composition exhibits an intrinsic viscosity of at least about 0.7 dl/g; and wherein the polyester composition has a lead content of less than about 10 ppm.

15. A polymer blend comprising:
a) a first polymer component comprising at least one polyester composition according to claim 1; and
b) a second polymer component.

16. The polymer blend of claim 15, wherein the second polymer component comprises one or more of at least one polycarbonate, polyester, styrene acrylonitrile, acrylonitrile butadiene styrene, methyl methacrylate, methacrylate butadiene styrene, styrene maleic anhydride, styrene butadiene styrene, styrene ethylene butadiene styrene, polystyrene, polyolefin, or polyetherimide, or a combination thereof.

17. The polymer blend of claim 15, further comprising at least one additive including a stabilizer, antioxidant, colorant, impact modifier, flame retardant, anti-drip additive, mold release additive, lubricant, plasticizer, mineral, reinforcement additive, UV additive, or phosphorus-containing additives, or a combination thereof.

18. The polymer blend of claim 15, wherein the polyester composition comprises the reaction product of:
a) a precursor component comprising a xanthene dicarboxylic acid or a reactive derivative thereof, or a combination thereof;
b) a terephthalate component comprising diethyl terephthalate or diethyl terephthalate;
c) a diol component comprising 1,4-cyclohexane dimethanol; and
d) at least one metal catalyst present in an amount from about 50 ppm to about 300 ppm;
wherein the polyester composition exhibits a glass transition temperature of at least about 105° C.; wherein the polyester composition exhibits an intrinsic viscosity of at least about 0.7 dl/g as measured using ASTM D2857; and
wherein the polyester composition has a lead content of less than about 10 ppm.

19. An article comprising the polymer blend of claim 15.

20. The article of claim 19, wherein the article is a molded article.

21. The article of claim 20, wherein the molded article is injected molded, extrusion molded, or blow molded wherein at least a portion of the article has a wall thickness from about 1.0 to about 5.0 mm and a percent transmission of greater than or equal to 60%.

22. A method for preparing a polyester composition, the method comprising:
a) providing a precursor component comprising xanthene dicarboxylic acid, a reactive derivative thereof, or a xanthene ester, or a combination thereof;
b) providing a terephthalate component comprising at least one di(C1-3 alkyl) terephthalate, or terephthalic acid, or a combination thereof;
c) providing a diol component comprising 1,4-cyclohexane dimethanol; and
d) reacting the precursor component, terephthalate component, and diol component under conditions effective to provide a reaction product comprising a polyester; wherein the conditions effective further comprise removing a C1 to C3 alcohol or water or a combination thereof,
wherein the polyester exhibits a glass transition temperature of at least about 105° C., and wherein the polyester exhibits an intrinsic viscosity of at least about 0.7 dl/g.

23. The method of claim 22, wherein conditions effective comprise polymerizing the precursor component, terephthalate component, and diol component in the presence of catalyst.

24. The method of claim 23, wherein the catalyst comprises at least one metal catalyst comprising an antimony compound, a tin compound, a titanium compound, a germanium compound, a zirconium compound, a zinc compound, or a cerium compound, or a combination thereof.

25. The method of claim 24, wherein the xanthene ester comprises at least one ester comprising a carbon chain ranging from C1 to C3.

26. The method of claim 24, wherein the xanthene ester comprises at least one ester and at least one carboxylic acid.

27. The method of claim 24, wherein the di(C1-3 alkyl) terephthalate is diethyl terephthalate.
